(19) United States
(12) Patent Application Publication
(10) Pub. No.: US 2026/0230964 A1
(43) Pub. Date: Aug. 6, 2026

(54) FALLBACK FOR TIME ALIGNMENT DURING MOBILITY

(71) Applicant: Telefonaktiebolaget LM Ericsson (PUBL), Stockholm (SE)

(72) Inventors: Icaro Leonardo DA SILVA, SOLNA (SE); Claes TIDESTAV, BÅLSTA (SE); Antonino ORSINO, KIRKKONUMMI (FI); Jens BERGQVIST, LINKÖPING (SE)

(21) Appl. No.: 19/147,800

(22) PCT Filed: Jan. 16, 2024
(86) PCT No.: PCT/SE2024/050033

§ 371 Date: Jul. 14, 2025

Related U.S. Application Data
(60) Provisional application No. 63/439,231, filed on Jan. 16, 2023.

(51) Int. Cl. H04W 36/04; H04W 36/00; H04W 56/00; H04W 72/231; H04W 74/0833

(52) U.S. Cl. CPC H04W 36/04; H04W 36/0072; H04W 56/0015; H04W 72/231; H04W 74/0833

(57) ABSTRACT

A method is performed by a wireless device for layer one (L1)/layer two (L2) triggered mobility (LTM). The method comprises: obtaining an uplink configuration for an LTM candidate cell; receiving a first indication from a serving cell to perform an uplink transmission in the candidate cell; transmitting a first uplink transmission in the candidate cell with a first transmit power and on a first uplink time/frequency resource; receiving a second indication from the serving cell to perform an uplink transmission in the candidate cell; transmitting a second uplink transmission in the candidate cell, wherein the second uplink transmission is transmitted with one or more of a second transmit power different from the first transmit power and a second uplink time/frequency resource different from the first time/frequency resource; and receiving, from the serving cell, a timing advance value for the candidate cell based on the second uplink transmission.

### TECHNICAL FIELD

Embodiments of the present disclosure are directed to wireless communications and, more particularly, to fallback for time alignment during mobility.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Fifth generation (5G) New Radio (NR) wireless networks use timing advance (TA) for uplink synchronization. Different user equipment (UE) in the same cell may typically be located at different positions within the cell and then with different distances to the base station (e.g., NR gNodeB). The transmissions from different UEs thus suffer from different delays until they reach the base station. To ensure that the uplink (UL) transmissions from a UE reaches the base station within the corresponding receive window for the base station, an uplink timing control procedure is therefore used. This avoids intracell interference occurring, both between UEs assigned to transmit in consecutive subframes and between UEs transmitting on adjacent subcarriers.

Time alignment of the uplink transmissions is achieved by applying a timing advance at the UE transmitter, relative to the received downlink timing. The main role of this is to counteract differing propagation delays between different UEs, as shown in the example below for an LTE eNodeB:

To achieve the time alignment, to obtain uplink synchronization, the base station (e.g., gNodeB, eNodeB) derives the TA value that the UE needs to use for the uplink transmissions to reach the base station within the receive window and indicates this to the UE. When the UE first accesses a cell, the UE uses a random-access procedure where the received Msg1 (the physical random access channel (PRACH) preamble) is used by the base station to determine the UE's initial TA to use for uplink transmissions in the cell. During the connection the base station then continuously monitors whether the UE needs to advance/delay the uplink transmissions to compensate for changes in propagation delay, and indicates to the UE if there is a need to change the TA value. The timing advance value may be referred as TA value and may either be an actual timing adjustment value to be applied and/or an index (e.g., TA) pointing to a timing adjustment value to be applied.

When the UE has a connection to several different serving cells, the same TA value may sometimes be used for more than one of the cells, e.g., if the cells are co-located and thus always would have the same distance to a UE. Such cells can then be configured as belonging to the same timing advance group (TAG). The configuration of TAGs is done per cell group, i.e., serving cells may be configured as belonging to the same TAG only if they belong to the same cell group (master cell group (MCG) or secondary cell group (SCG)). Further details are provided below.

When the UE does not perform uplink transmissions for some time in a serving cell, the TA value that the UE used earlier may no longer be accurate, e.g., because the UE has moved and thus has a different propagation delay. In that case, if the UE performs an uplink transmission using the latest received TA value, the uplink transmission may reach the base station outside the receive window and thus not be correctly received by the base station. The transmission may then even interfere with other uplink transmissions (from other UEs). A timer timeAlignmentTimer (which may be referred as a time alignment timer or TA timer) is therefore configured for each TAG to indicate how long the UE can consider itself to be uplink time aligned to serving cells belonging to the associated TAG without receiving any updates to the TA value. The timeAlignmentTimer thus indicates how long a duration of time the UE may consider a received TA value as valid. If the UE does not receive an updated value before timeAlignmentTimer expires, the UE is no longer uplink synchronized to the serving cells belonging to the corresponding TAG.

In a random access (RA) procedure in NR, the UE first selecta a beam (spatial direction) by selecting a synchronization signal block (SSB) or channel state information reference signal (CSI-RS) resource of a target cell in which the UE intends to perform the RA procedure. The selected SSB or CSI-RS resource maps to a RA resource (i.e., a preamble and/or a time/frequency resource of a RA channel (RACH) of the target cell).

The UE transmits the selected preamble in the selected RACH resource and expects to receive a RA response (RAR) during a configured RAR time window. If the UE transmits the preamble and does not receive the RAR during the configured RAR time window, the UE performs what is referred to as RA fallback, which consists of the UE performing a re-selection of a RA resource, by the selection of a new beam (i.e., new SSB and/or CSI-RS) mapping to a new RA resource and/or a preamble power ramping (i.e., increasing the transmission power for the preamble transmission). This may be done up to a maximum number of times configured by the network, and when the maximum number is reached, the UE declares a RA failure.

This may be summarized as follows, for the case of a contention-based random access during a reconfiguration with sync to a target cell:

```
[38.321]
5.1.4 Random Access Response reception
Once the Random Access Preamble is transmitted and regardless of the possible occurrence
of a measurement gap, the MAC entity shall:
  [...]
  1>if ra-Response Window configured in RACH-ConfigCommon expires, and if the
    Random Access Response containing Random Access Preamble identifiers that
    matches the transmitted PREAMBLE INDEX has not been received:
    2>consider the Random Access Response reception not successful;
    2>increment PREAMBLE TRANSMISSION COUNTER by 1;
    2>if PREAMBLE TRANSMISSION COUNTER = preambleTransMax + 1:
    3>if the Random Access Preamble is transmitted on the SpCell:
    4>indicate a Random Access problem to upper layers;
    [...]
    2>if the Random Access procedure is not completed:
      3>select a random backoff time according to a uniform distribution between 0 and
      the PREAMBLE BACKOFF;
      3>if the criteria (as defined in clause 5.1.2) to select contention-free Random Access
        Resources is met during the backoff time:
        4>perform the Random Access Resource selection procedure (see clause 5.1.2);
      3>else:
        4>perform the Random Access Resource selection procedure (see clause 5.1.2)
          after the backoff time.
[...]
[38.321]
5.1.2 Random Access Resource selection
The MAC entity shall:
      [...]
  1>else (i.e. for the contention-based Random Access preamble selection):
    2>if at least one of the SSBs with SS-RSRP above rsrp-ThresholdSSB is available:
      3>select an SSB with SS-RSRP above rsrp-ThresholdSSB.
    2>else:
      3>select any SSB.
      [...]
    2>select a Random Access Preamble randomly with equal probability from the
      Random Access Preambles associated with the selected SSB and the selected
      Random Access Preambles group.
    2>set the PREAMBLE INDEX to the selected Random Access Preamble.
    [...]
  1>else if an SSB is selected above:
    2> determine the next available PRACH occasion from the PRACH occasions
      corresponding to the selected SSB permitted by the restrictions given by the ra-ssb-
      OccasionMaskIndex if configured or indicated by PDCCH (the MAC entity shall
      select a PRACH occasion randomly with equal probability amongst the consecutive
      PRACH occasions according to clause 8.1 of TS 38.213, corresponding to the
      selected SSB; the MAC entity may take into account the possible occurrence of
      measurement gaps when determining the next available PRACH occasion
      corresponding to the selected SSB).
  1>else if a CSI-RS is selected above:
      [...]
  1>perform the Random Access Preamble transmission procedure (see clause 5.1.3).
  NOTE: When the UE determines if there is an SSB with SS-RSRP above rsrp-
        ThresholdSSB or a CSI-RS with CSI-RSRP above rsrp-ThresholdCSI-RS, the UE
        uses the latest unfiltered L1-RSRP measurement.
5.1.3 Random Access Preamble transmission
The MAC entity shall, for each Random Access Preamble:
  1>if PREAMBLE TRANSMISSION_COUNTER is greater than one; and
  1>if the notification of suspending power ramping counter has not been received from
    lower layers; and
  1>if SSB or CSI-RS selected is not changed from the selection in the last Random Access
    Preamble transmission:
    2>increment PREAMBLE POWER RAMPING COUNTER by 1.
  1>select the value of DELTA PREAMBLE according to clause 7.3;
  1>set PREAMBLE RECEIVED TARGET POWER to preambleReceivedTargetPower +
    DELTA PREAMBLE + (PREAMBLE POWER RAMPING COUNTER- 1) ×
    PREAMBLE POWER RAMPING STEP;
  1>except for contention-free Random Access Preamble for beam failure recovery request,
    compute the RA-RNTI associated with the PRACH occasion in which the Random
    Access Preamble is transmitted;
  1>instruct the physical layer to transmit the Random Access Preamble using the selected
    PRACH occasion, corresponding RA-RNTI (if available), PREAMBLE INDEX and
    PREAMBLE RECEIVED TARGET POWER.
[...]
```

*******************************************************************

Third Generation Partnership Project (3GPP) work includes a work item on further NR mobility enhancements, in particular, in a technical area entitled L1/L2 based inter-cell mobility. See Work Item Description (WID) in RP-213565 for further details.

According to the WID, when a UE moves from the coverage area of one cell to another cell, at some point a serving cell change needs to be performed. Currently, serving cell change is triggered by layer three (L3) measurements and is done by Radio Resource Control (RRC) signaling triggered Reconfiguration with Synchronization for change of PCell and PSCell, as well as release add for SCells when applicable. All cases involve complete layer two (L2) (and layer one (L1)) resets, leading to longer latency, larger overhead and longer interruption time than beam switch mobility. The goal of L1/L2 mobility enhancements is to enable a serving cell change via L1/L2 signaling to reduce the latency, overhead, and interruption time.

One goal is that L1-L2 inter-cell mobility should be like an inter-cell beam management, i.e., to support L1-L2 inter-cell mobility the UE should be configured to perform measurements on cells that are not the serving cells as defined up to Rel-17. In Rel-17, to support inter-PCI mTRP operation, a solution has been standardized where a CSI resource may be associated to a primary cell identifier (PCI) that is not the same PCI of one of the serving cells. In that solution, the UE receives an explicit indication of which beams (SSBs) and PCIs to be measured for a given reporting configuration.

The goal is to specify mechanism and procedures of L1/L2 based inter-cell mobility for mobility latency reduction. These include: configuration and maintenance for multiple candidate cells to facilitate fast application of configurations for candidate cells; dynamic switch mechanism among candidate serving cells (including SpCell and SCell) for the potential applicable scenarios based on L1/L2 signaling; L1 enhancements for inter-cell beam management, including L1 measurement and reporting, and beam indication; timing advance management; and CU-DU interface signaling to support L1/L2 mobility, if needed.

The procedure of L1/L2 based inter-cell mobility is applicable to the following scenarios: standalone, carrier aggregation (CA) and NR dual connectivity (DC) case with serving cell change within one CG; intra-DU case and intra-CU inter-DU case (applicable for standalone and CA); both intra-frequency and inter-frequency; both frequency range one (FR1) and frequency range two (FR2); and source and target cells may be synchronized or non-synchronized.

There currently exist certain challenges. For example, one of the issues to resolve for L1/L2 inter-cell mobility is the timing advance management (which may include the handling of a time alignment timer). In legacy L3 handover, the timing advance is established between the UE and the target cell with a random access procedure by the UE transmitting a preamble to the target cell and receiving a RAR from the target cell, including a time alignment value to be applied.

The performance enhancements for L1/L2-based inter-cell mobility to reduce handover interruption time include solutions to reduce the time for UE reconfiguration and downlink and uplink synchronization after handover decision. In one proposed solution, a UE transmits a RA preamble to a candidate cell and, differently from a legacy RA procedure, the UE does not expect a RAR including a TA value from the candidate cell in response. Instead, the UE transmits the RA preamble to enable the candidate target network node (e.g., candidate Distributed Unit-DU) to calculate the timing advance value (i.e., the amount of timing adjustment the UE needs to apply for uplink synchronization) and provide that value (or an index/indication of that value) to the source DU (S-DU). The S-DU may provide that value or associated value to the UE only when it is time to execute L1/L2 triggered mobility (LTM) to the candidate cell. An example is illustrated in FIGS. 1A and 1B.

FIGS. 1A and 1B is a flowchart illustrating an example in which the TA establishment based on RA preamble transmission to candidate and reception of TA value only at LTM execution, e.g., in the MAC CE for the LTM cell switch command. In this solution, the UE can transmit a preamble to enable the network to calculate the timing advance value for a candidate cell without the need for the UE to wait for the reception of a RAR in the candidate cell. This reduces the interruption in the transmissions/receptions in the source cell, because after the RA preamble transmission in the candidate cell, the UE would also have to monitor a control channel (like physical downlink control channel (PDCCH)) in the candidate cell for the possible reception of the RAR. 3GPP work items includes the following agreements regarding LTM.
On mechanism to acquire TA of the candidate cell(s) in Rel-18 LTM, at least support PDCCH ordered RACH.
   The PDCCH order is only triggered by source cell
Support TA acquisition of candidate cell(s) before cell switch command is received in L1/L2 based mobility.
For PDCCH ordered RACH in LTM, at least the following enhancements are supported
   Introduce indication of candidate cell and/or RO of candidate cell in DCI
   configuration of RACH resource for candidate cell(s) is provided prior to the PDCCH order
TA updating (i.e. re-acquisition of TA) for candidate cell can be triggered by NW.
   same triggering mechanism reuse the initial TA acquisition, i.e., PDCCH order triggered RACH in a candidate cell

The fact that the UE does not expect a RAR in the candidate cell after transmitting a RA preamble creates problems, because it is the reception of the RAR that acknowledges to the UE that a preamble transmission was successfully received by the network. Thus, without a RAR from the candidate cell, the UE does not know whether the preamble was successfully received or not, and/or whether the UE needs to re-transmit the preamble. At the same time, having a RAR means that the UE needs to monitor the control channel of the candidate cell, which increases the interruption with the source cell.

### Summary

As described above, certain challenges currently exist with s fallback for time alignment during mobility. Certain aspects of the present disclosure and their embodiments may provide solutions to these or other challenges. For example, particular embodiments include network based fallback for timing advance (TA) establishment/updating.

Some embodiments include a method at a user equipment (UE) capable of layer one (L1)/layer two (L2) triggered mobility (LTM) and configured with at least one LTM candidate cell. The method comprises handling of failed attempt(s) to perform TA establishment and/or TA updating (e.g., by the UE performing another preamble transmission).

The method comprises the UE receiving (1) a first downlink (DL) indication from a source network node (e.g., source distributed unit (DU) (S-DU)), and (2) in response to the first downlink indication, the UE transmitting to the LTM candidate cell a first uplink (UL) message (e.g., a first random access (RA) preamble), wherein the uplink message is transmitted with a first transmission power and on a first uplink resource (e.g., RA resources in time and frequency), wherein the first uplink resource is associated to the LTM candidate cell.

In some embodiments, the UE selects a first beam, and based on the selected first beam the UE selects a first uplink resource associated to for transmitting the first uplink message.

In some embodiments, the UE further receives a second downlink indication, also from the source network node (e.g. S-DU). In response to the second downlink indication, the UE transmits a second uplink message (e.g., a second RA preamble) also to the LTM candidate cell, wherein the second uplink message (e.g., second RA preamble) is transmitted to the LTM candidate cell according to: i) an incremented transmission power compared to the first transmission power or ii) on a second uplink resource (e.g., RA resources in time and frequency) associated to the LTM candidate cell. Typically, the source network node (e.g., S-DU) would transmit the second downlink indication to the UE when the first uplink message is not successfully received (at the candidate DU (C-DU)), but the UE may not necessarily be aware of that failure at the C-DU.

In some embodiments, the second downlink indication is associated to the first downlink indication. Based on the second indication being associated to the first downlink indication, the UE transmits the second uplink message (e.g., second RA preamble) to the LTM candidate cell according to: i) an incremented transmission power compared to the first transmission power or ii) on a second uplink resource (e.g., RA resources in time and frequency) associated to the LTM candidate cell.

In some embodiments, in response to the reception of the second downlink indication, the UE selects a second beam (e.g., synchronization signal block (SSB) or channel state information reference signal (CSI-RS) of the LTM candidate cell), and based on the selected second beam the UE selects the second uplink resource (e.g., RA resources in time and frequency) associated to the LTM candidate cell for transmitting the second uplink message.

In general terms, the UE further receives an (n+1)-th downlink indication, also from the source network node (e.g., S-DU). In response to the (n+1)-th downlink indication, the UE transmits an (n+1)-th uplink message (e.g., an (n+1)-th RA preamble) also to the LTM candidate cell, wherein the (n+1)-th uplink message (e.g. (n+1)-th RA preamble) is transmitted to the LTM candidate cell according to: i) an incremented transmission power compared to the n-th transmission power, or ii) on an (n+1)-th uplink resource (e.g., RA resources in time and frequency) associated to the LTM candidate cell. At the network side, the S-DU would keep transmitting a downlink indication for triggering a preamble transmission until one or more criteria are fulfilled, e.g., maximum number of attempts is reached, or until an uplink signal/message is successfully received. In other words, the process is repeated until the uplink signal/message is successfully received in the candidate DU, and the candidate DU is able to calculate a TA value, or a maximum number of attempts is reached (see network description for further details).

In some embodiments, the (n+1)-th downlink indication is associated to the n-th downlink indication. Based on that the (n+1)-th indication being associated to the n-th downlink indication, the UE transmits the (n+1)-th uplink message (e.g., (n+1)-th RA preamble) to the LTM candidate cell according to: i) an incremented transmission power compared to the n-th transmission power, or ii) on a (n+1)-th uplink resource (e.g., RA resources in time and frequency) associated to the LTM candidate cell.

In a dependent step, (3) in response to the reception of the (n+1)-th downlink indication, the UE selects a k-th beam (e.g., SSB or CSI-RS of the LTM candidate cell), and based on the selected k-th beam the UE selects the (n+1)-th uplink resource (e.g., RA resources in time and frequency) associated to the LTM candidate cell, for transmitting the (n+1)-th uplink message.

In some embodiments, the UE further receives a TA value (calculated by the network according to the second uplink message received at the Candidate DU). Different sets of embodiments described herein disclose different ways to provide the TA value, e.g., during LTM execution/cell switch to the LTM candidate cell (based on the received second uplink signal, the candidate DU was able to calculate a TA value for the UE associated to the LTM candidate cell).

In some embodiments, in an LTM cell switch (LTM execution) to the LTM candidate cell, the UE transmits an uplink message on a physical uplink control channel (PUCCH) or physical uplink shared channel (PUSCH) based on the received TA value.

FIGS. 2A and 2B is a flow diagram summarizing UE actions in the network-based fallback for TA establishment.

Some embodiments include a method at a serving DU (S-DU) comprising the S-DU transmitting to a UE a first downlink indication based on which the UE transmits to an LTM candidate cell a first uplink message (e.g., a first RA preamble), wherein the uplink message is to be transmitted by the UE with a first transmission power and on a first uplink resource (e.g., RA resources in time and frequency) associated to the LTM candidate cell. Then, the S-DU detecting that the first uplink message is not successfully received at a C-DU responsible for the LTM candidate cell, and in response to that transmitting to the UE a second downlink indication, which is associated with the first downlink indication, based on which the UE transmits a second uplink message (e.g., second RA preamble) also to the LTM candidate cell, wherein the second uplink message transmitted to the candidate cell is to be transmitted according to: i) an incremented transmission power compared to the first transmission power or ii) on a second uplink resource (e.g., RA resources in time and frequency) associated to the LTM candidate cell.

In some embodiments, the S-DU receives from the candidate DU a TA value (calculated by the C-DU according to the second uplink signal received at the C-DU).

In some embodiments, the S-DU further transmits to the UE a TA value (calculated by the C-DU according to the second uplink signal received at the C-DU), e.g., included in the LTM cell switch command indicating the UE to move to the LTM candidate cell.

In some embodiments, the S-DU determines that the first uplink message is not successfully received at the candidate DU when a supervision timer expires. That timer is started by the S-DU when the S-DU transmits the first downlink indication to the UE. That is stopped when the S-DU receives a message from the C-DU (e.g., via the CU) including a TA value calculated based on the transmission of the first uplink message. This is herein referred to as a supervision timer, but the functionality may also be modeled as a time window in which the message from the C-DU is expected to be received and when it is not received in that time window the S-DU considers the attempt as a failed attempt.

In some embodiments, the S-DU monitors a counter for the number of uplink signal/message transmission attempts (e.g., maximum number of RA preamble transmission attempts). Thus, each time the S-DU provides a downlink indication to the UE after the first downlink indication the counter is incremented. There is a maximum value this counter can reach and when that value is reached, the S-DU declares a failure in the TA establishment procedure. Before the S-DU transmits a second indication, the S-DU checks whether the maximum value has been reached. When that has been reached, the S-DU declares a TA establishment failure.

In some embodiments, if the S-DU determines that the first uplink message is not successfully received at the candidate DU, when transmitting the second downlink message to trigger a second RA preamble transmissions at the UE, the S-DU may indicate also a new LTM candidate cell (e.g., by indicating an LTM configuration ID) and/or the beam or transmission configuration indicator (TCI) state (to which the second RA preamble needs to be transmitted).

In some embodiments, the S-DU counts the increments in the transmission power of the uplink signals/message. When the transmission power is indicated to be incremented by the UE the S-DU increments the variable. There is a maximum value for the transmission power and when that value is reached after re-transmissions, the S-DU declares a failure in the TA establishment procedure.

Some embodiments include a method at a candidate DU (C-DU) comprising the C-DU detecting whether a first uplink message is successfully or not successfully received at the C-DU (responsible for the LTM candidate cell); and when the uplink message is successfully received, calculating a TA value based on the first uplink message that is received and transmitting that TA value to the S-DU in a message; or when the first uplink message is not successfully received, performing one or more of: i) transmitting to the S-DU (e.g., via the CU) a message which does not include a TA value; ii) do not transmit the message to the S-DU (e.g., via the CU).

In summary, a method at a UE capable of LTM and configured with at least one LTM candidate cell comprises receiving (1) a first downlink indication from a serving cell (of a source network node, e.g. Source DU (S-DU)), and (2) in response to the first downlink indication the UE transmitting to a first LTM candidate cell a first uplink message (e.g., a first RA preamble), wherein the uplink message is transmitted with a first transmission power and on a first uplink resource (e.g., RA resources in time and frequency). The method further comprises further receiving a second downlink indication from the source network node (e.g., S-DU). In response to receiving the second downlink indication, the method comprises transmitting a second uplink message (e.g., a second RA preamble) to a second LTM candidate cell, wherein the second uplink message (e.g., second RA preamble) is transmitted to the LTM candidate cell according to: i) an incremented transmission power compared to the first transmission power or ii) on a second uplink resource (e.g., RA resources in time and frequency) associated to the LTM candidate cell.

In some embodiments, the LTM candidate cell is the same as the second LTM candidate cell. In some embodiments, the first LTM candidate cell is different from the second LTM candidate cell.

In some embodiments, the method further comprises the UE selecting a first beam, and based on the selected first beam the UE selecting a first uplink resource associated to for transmitting the first uplink message.

According to some embodiments, a method is performed by a wireless device for LTM. The method comprises: obtaining an uplink configuration for an LTM candidate cell; receiving a first indication from a serving cell to perform an uplink transmission in the LTM candidate cell; transmitting a first uplink transmission in the LTM candidate cell with a first transmit power and on a first uplink time/frequency resource; receiving a second indication from the serving cell to perform an uplink transmission in the LTM candidate cell; transmitting a second uplink transmission in the LTM candidate cell, wherein the second uplink transmission is transmitted with one or more of a second transmit power different from the first transmit power and a second uplink time/frequency resource different from the first time/frequency resource; and receiving, from the serving cell, a timing advance value for the LTM candidate cell based on the second uplink transmission.

In particular embodiments, the first uplink transmission and the second uplink transmission comprise transmission of a random access preamble.

In particular embodiments, the wireless device does not expect a RAR in response to the transmission of the random access preamble.

In particular embodiments, the first uplink transmission uses a first beam and in response to receiving the second indication to perform the uplink transmission, the method further comprises selecting a second beam to use for the second uplink transmission and when the second beam is the same as the first beam the second transmission is transmitted with a second transmit power different from the first transmit power and when the second beam is different from the first beam the second transmission is transmitted with a second uplink time/frequency resource different from the first time/frequency resource.

In particular embodiments, the second indication to perform the uplink transmission comprises an indication of a second transmission power or an indication of a second uplink time/frequency resource to use for the second uplink transmission.

In particular embodiments, the first indication and the second indication comprise a PDCCH order.

In particular embodiments, receiving the timing advance value from the serving cell comprises receiving an LTM execution command.

In particular embodiments, the uplink configuration for the uplink candidate cell comprises one or more random access parameters and at least one of the first indication and the second indication comprises an indication of which of the one or more random access parameters to use for the first uplink transmission or the second uplink transmission, respectively.

In particular embodiments, at least one of the first indication and the second indication comprises an indication of a SSB associated with the first uplink transmission or the second uplink transmission, respectively.

In particular embodiments, the uplink configuration for the uplink candidate cell comprises more than one uplink configuration for more than one uplink candidate cell and at least one of the first indication and the second indication comprises an indication of which uplink candidate cell in which to transmit the first uplink transmission or the second uplink transmission, respectively.

According to some embodiments, a wireless device comprises processing circuitry operable to perform any of the wireless device methods described above.

Another computer program product comprises a non-transitory computer readable medium storing computer readable program code, the computer readable program code operable, when executed by processing circuitry to perform any of the methods performed by the wireless device described above.

According to some embodiments, a method is performed by a network node operating as a S-DU for TA management between a wireless device and at least one LTM candidate cell The method comprises transmitting a first indication to the wireless device to perform an uplink transmission in the LTM candidate cell and transmitting a second indication to the wireless device to perform an uplink transmission in the LTM candidate cell.

In particular embodiments, the method further comprises transmitting the second indication to the wireless device to perform the uplink transmission in the LTM candidate cell upon detecting the uplink transmission in the LTM candidate cell was unsuccessful.

In particular embodiments, detecting the uplink transmission in the LTM candidate cell was unsuccessful comprises not receiving a response from the LTM candidate cell or receiving an indication from the LTM candidate cell that the uplink transmission in the LTM candidate cell was unsuccessful.

In particular embodiments, the first uplink transmission and the second uplink transmission comprise transmission of a random access preamble.

In particular embodiments, the second indication to perform the uplink transmission comprises an indication of a transmission power or an uplink time/frequency resource to use for the second uplink transmission.

In particular embodiments, the first indication and the second indication comprise a PDCCH order.

In particular embodiments, the method further comprises receiving a timing advance value from the candidate LTM cell and transmitting the timing advance value to the wireless device.

In particular embodiments, transmitting the timing advance value to the wireless device comprises transmitting a LTM execution command to the wireless device.

In particular embodiments, transmitting the second indication to the wireless device to perform the uplink transmission comprises determining a threshold number of uplink transmissions for the wireless device and the LTM candidate cell has not been exceeded.

In particular embodiments, the method further comprises transmitting an uplink configuration for the uplink candidate cell to the wireless device. The uplink configuration for the uplink candidate cell may comprise one or more random access parameters and at least one of the first indication and the second indication comprises an indication of which of the one or more random access parameters to use for the first uplink transmission or the second uplink transmission, respectively. The uplink configuration for the uplink candidate cell may comprise more than one uplink configuration for more than one uplink candidate cell and at least one of the first indication and the second indication comprises an indication of which uplink candidate cell in which to transmit the first uplink transmission or the second uplink transmission, respectively.

In particular embodiments, at least one of the first indication and the second indication comprises an indication of a synchronization signal block, SSB, associated with the first uplink transmission or the second uplink transmission, respectively.

According to some embodiments, a network node comprises processing circuitry operable to perform any of the network node methods described above.

Another computer program product comprises a non-transitory computer readable medium storing computer readable program code, the computer readable program code operable, when executed by processing circuitry to perform any of the methods performed by the network node described above.

Certain embodiments may provide one or more of the following technical advantages. For example, particular embodiments establish and update the time alignment (timing advance adjustments) between the UE and an LTM candidate cell, which is a cell that may not be uplink synchronized with a serving cell the UE is configured with, and consequently, not uplink synchronized with the UE. Thus, particular embodiments enable the UE to execute an LTM cell switch (e.g., upon reception of a MAC CE for LTM) and transmit uplink information to the candidate cell (e.g., on PUSCH or PUCCH) without the need to first perform a RA procedure, which reduces the interruption time during LTM execution, leads to more efficient usage of network radio resources, and better UE energy consumption.

In addition, an advantage of particular embodiments is the possibility to handle failed attempts to transmit the uplink signals/messages (e.g., RA preambles) during TA establishment and/or updating between the UE and an LTM candidate cell. Because of that it is possible to trigger a re-transmission of an uplink message to the candidate LTM when the Candidate DU is not able to detect a previous preamble transmission, which makes the TA establishment and updates more robust, efficient and unambiguous in an interoperable network.

Particular embodiments include a network-based fallback for TA establishment. In one set of embodiments, the UE transmits a RA preamble to the LTM candidate cell but does not rely on the reception of a RAR in the LTM candidate cell; thus, the interruption time with the serving cell(s) for the TA establishment and updates procedure is minimized, which is beneficial for the data rates provided by the serving cell(s), as more data may be scheduled (as there would be fewer scheduling restrictions imposed by the serving cell(s)). At the same time, due to the absence of the RAR, the UE could not determine whether the attempted transmission was successful or not. Then, the benefit of the network-based fallback is that the S-DU determines whether the attempt was successful or not, and when that was not successful it indicates to the UE to transmit another uplink signal/message, i.e., the S-DU indicates to the UE a need for a fallback, e.g. power ramping and/or a beam selection.

In other words, some differences compared to a RA procedure are that: i) the downlink indication, received by the UE in response to a preamble transmission on the LTM candidate cell, is received from a serving cell (from the S-DU); ii) the reception of a downlink indication indicates a failed attempted, different from a RAR, which indicates a successful attempt. Another difference compared to a legacy RA procedure is that the monitoring of failed and successful attempts is performed at the network side instead of at the UE, which offloads some responsibilities from the UE.

### BRIEF DESCRIPTION OF THE DRAWINGS

For a more complete understanding of the disclosed embodiments and their features and advantages, reference is now made to the following description, taken in conjunction with the accompanying drawings, in which:

FIGS. 1A and 1B is a flowchart illustrating an example in which the timing advance (TA) establishment based on random access (RA) preamble transmission to candidate and reception of TA value only at layer one (L1)/layer two (L2) triggered mobility (LTM) execution;

FIGS. 2A and 2B is a flow diagram summarizing UE actions in the network-based fallback for TA establishment;

FIG. 3 is a block diagram illustrating the architecture of a central unit (CU) and a distributed unit (DU) in a radio access network (RAN);

FIGS. 4A and 4B illustrate Abstract Syntax Notation (ASN) for six examples of LTM candidate configuration;

FIGS. 5A, 5B and 5C is a flowchart illustrating an example of steps for the LTM configuration and TA establishment/updating, according to a particular embodiment;

FIGS. 6A, 6B and 6C is a flowchart illustrating a fallback procedure for the TA update procedure;

FIGS. 7A, 7B and 7C is a flowchart illustrating another fallback procedure for the TA update procedure;

FIGS. 8A and 8B is a flowchart illustrating an example of actions at the S-DU upon detecting a TA establishment failure;

FIG. 9 illustrates an example communication system, according to certain embodiments;

FIG. 10 illustrates an example user equipment (UE), according to certain embodiments;

FIG. 11 illustrates an example network node, according to certain embodiments;

FIG. 12 illustrates a method performed by a user equipment, according to certain embodiments; and

FIG. 13 illustrates a method performed by a network node, according to certain embodiments.

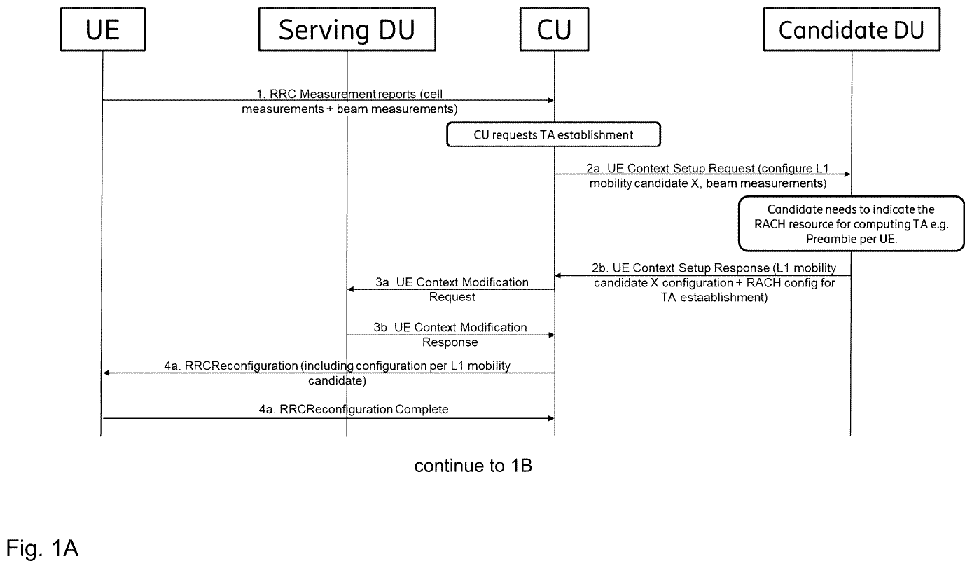

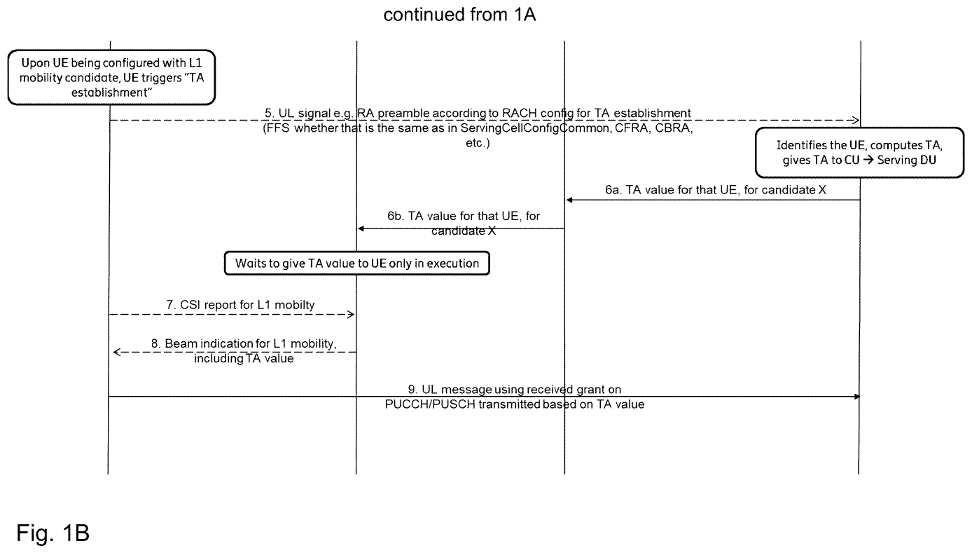

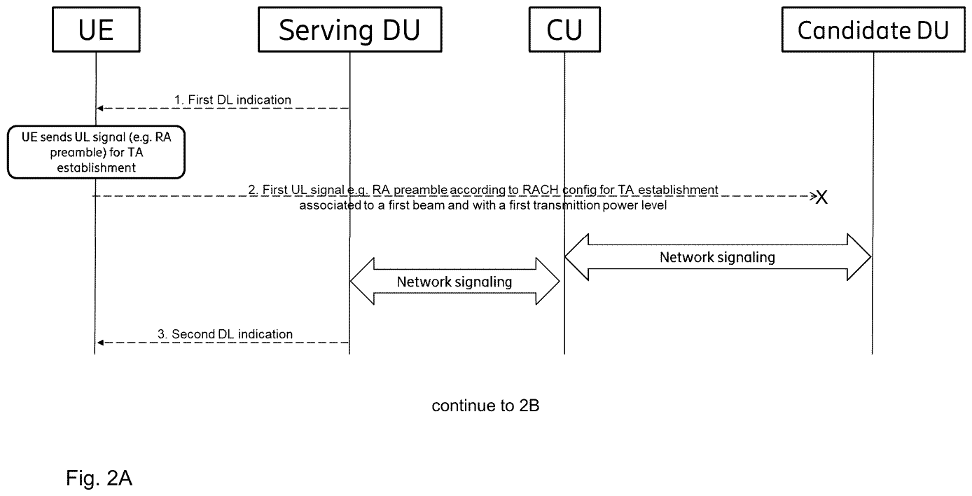

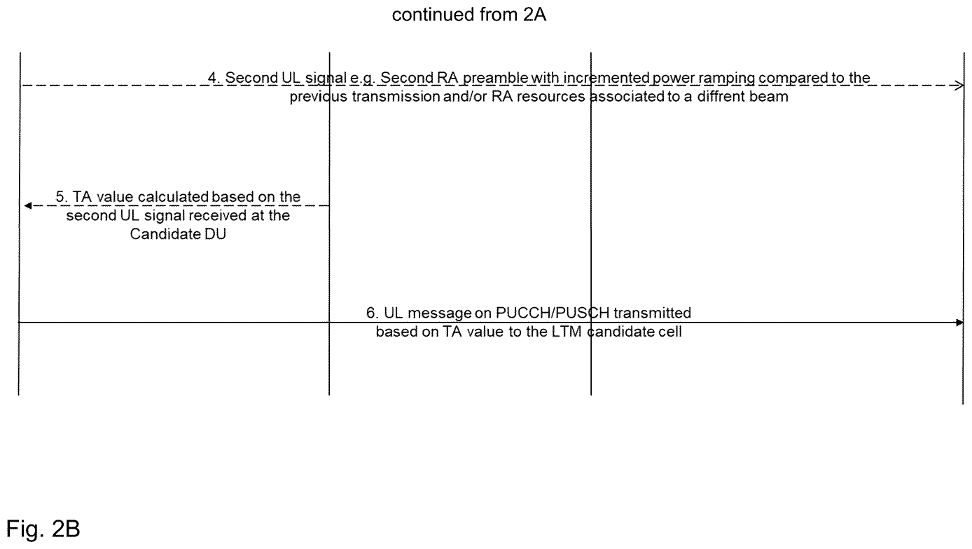

### DETAILED DESCRIPTION

As described above, certain challenges currently exist with s fallback for time alignment during mobility. Certain aspects of the present disclosure and their embodiments may provide solutions to these or other challenges. For example, particular embodiments include network based fallback for timing advance (TA) establishment/updating.

Particular embodiments are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

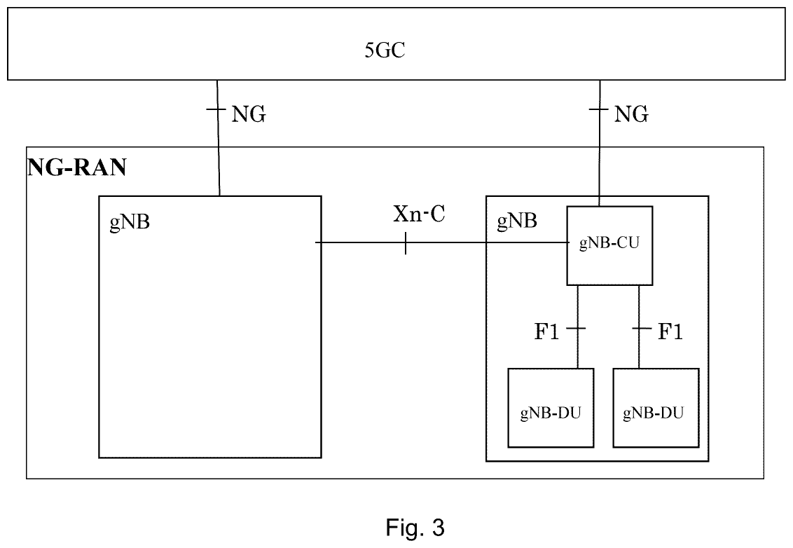

FIG. 3 is a block diagram illustrating the architecture of a central unit (CU) and a distributed unit (DU) in a radio access network (RAN). In the illustrated example, the RAN is a next-generation RAN (NG-RAN), which may be referred as the fifth generation (5G) RAN, however, particular embodiments are applicable to any RAN such as a sixth generation (6G) RAN architecture.

The illustrated architecture (with both NG-RAN and 5GC) shows the NG-RAN split in CU and DU connected via F1 interface. The RAN (e.g., NG-RAN) consists of a set of RAN nodes (e.g., gNBs) connected to a core network (e.g., a 5GC) through a RAN/CN interface (e.g., NG interface). For NG-RAN, that may comprise one or more ng-eNBs, wherein an ng-eNB may consist of an ng-eNB-CU and one or more ng-eNB-DU(s). A gNB may consist of a gNB-CU and one or more gNB-DU(s). A gNB-CU and a gNB-DU are connected via F1 interface. A gNB-DU may be connected to multiple gNB-CUs by appropriate implementation.

NG, Xn and F1 are logical interfaces. For the NG-RAN, the NG and Xn-C interfaces for a gNB consisting of a gNB-CU and gNB-DUs terminate in the gNB-CU. For EN-DC, the S1-U and X2-C interfaces for a gNB consisting of a gNB-CU and gNB-DUs terminate in the gNB-CU. The gNB-CU and connected gNB-DUs are only visible to other gNBs and the 5GC as a gNB.

Some embodiments refer to a serving DU or source DU, whose acronym is used interchangeably as S-DU. The S-DU may correspond to a gNode-DU that is responsible for one or more serving cell(s) for which a user equipment (UE) is configured.

In some embodiments the CU refers to the CU the UE is connected with, i.e. the CU wherein the higher layer protocols (e.g., Radio Resource Control (RRC)) for communication with the UE are terminated and where a UE access stratum (AS) context is stored.

Some embodiments refer to a candidate DU (C-DU), which refers to the DU (which may correspond to a gNodeB-DU) that is responsible for a layer one (L1)/layer two (L2) triggered mobility (LTM) candidate cell for which a UE is configured. As part of the LTM configuration, the CU sends a request to the C-DU for configuring the LTM candidate cell for the UE. In response, the CU receives at least an LTM candidate cell configuration, which is the configuration based on which the UE determines the configuration it needs to use when it switches to that LTM candidate cell in an LTM execution (also referred to as LTM cell switch).

The text refers to the term “L1/L2 based inter-cell mobility” as used in the Work Item Description in 3GPP, though it interchangeably also uses the terms L1/L2 mobility, L1-mobility, L1 based mobility, L1/L2-centric inter-cell mobility, L1/L2 inter-cell mobility, or L1/L2 triggered mobility. The basic principle is that the UE receives a lower layer signaling from the network indicating to the UE a change (or switch or activation) of its serving cell (e.g., change of PCell from a source to a target PCell), wherein a lower layer signaling is a message/signaling of a lower layer protocol, which may be referred as a L1/L2 inter-cell mobility execution command (or LTM cell switch command). The change of serving cell (e.g., change of PCell) may lead to a change in Scell(s) for the same cell group, e.g. when the command triggers the UE to change to another cell group configuration of the same type (e.g., another master cell group (MCG) configuration). Before the UE receives the LTM cell switch command, the UE is configured by the network with one or more LTM candidate cells (e.g., reception of an RRC Reconfiguration message with at least one candidate cell configuration) A candidate cell configuration may include parameters in the information element (IE) CellGroupConfig per candidate cell and/or an embedded RRC Reconfiguration per candidate cell

A lower layer protocol refers to a lower layer protocol in the air interface protocol stack compared to RRC protocol, e.g. medium access control (MAC) is considered a lower layer protocol as it is “below” RRC in the air interface protocol stack, and in this case a lower layer signaling/message may correspond to a MAC control element (MAC CE). Another example of lower layer protocol is the Layer 1 (or physical layer, L1), and in this case a lower layer signaling/message may correspond to a downlink control information (DCI). Signaling information in a protocol layer lower than RRC reduces the processing time and, consequently, reduces the interruption time during mobility. In addition, it may also increase the mobility robustness because the network may respond to faster changes in the channel conditions.

Another relevant aspect in L1/L2 inter-cell mobility is that in multiple-beam scenario, a cell can be associated to multiple synchronization signal blocks (SSBs), and during a half-frame, different SSBs may be transmitted in different spatial directions (i.e., using different beams, spanning the coverage area of a cell). Similar reasoning may be applicable to channel state information reference signal (CSI-RS) resources, which may also be transmitted in different spatial directions. Thus, in L1/L2 inter-cell mobility (LTM), the reception of a lower layer signaling indicates the UE to change from one beam in the serving cell to another beam in a neighbor cell (which is a configured candidate cell), and by that changing serving cell.

The term LTM cell switch procedure refers to the process of a UE changing its cell from a source cell to a target cell (which may be referred to as a candidate cell), using L1/L2-triggered mobility. In the context of L1/L2 based inter-cell mobility or L1/L2-triggered mobility, the LTM cell switch procedure may also be referred to as dynamic switch, LTM switch, LTM cell switch, LTM serving cell change or LTM cell change. Even if the term change of cell is used, that may comprise a change of a whole cell group configuration, which includes a change in the SpCell (e.g., change of PCell, or change of PSCell) and a change in SCells of the cell group (e.g., addition, modification and/or release of one or more SCells).

Some examples use the term target candidate configuration (or configuration of a candidate cell, or configuration of an LTM candidate cell, or LTM candidate cell configuration) to refer to the configuration of a “L1/L2 inter-cell mobility candidate cell”, which is a cell the UE is configured with when configured with L1/L2 inter-cell mobility. That is a cell the UE can move to in a L1/L2 inter-cell mobility procedure, upon reception of a lower layer signaling (e.g., MAC CE including the LTM candidate cell configuration identifier). These cells may also be referred to as candidate cell(s), candidates, mobility candidates, non-serving cells, additional cells, target candidate cell, target candidate, etc. This is a cell the UE performs measurements on (e.g., CSI measurements) so that the UE reports these measurements and network may take educated decision on which beam (e.g., transmission configuration indicator (TCI) state) and/or cell to which the UE is to be switched. A L1/L2 inter-cell mobility candidate cell may be a candidate to be a target PCell or PSCell, or an SCell of a cell group (e.g., MCG SCell).

The term “beam” may correspond to a spatial direction in which a signal is transmitted (e.g., by a network node) or received (e.g., by the UE), or a spatial filter applied to a signal which is transmitted or received. Thus, transmitting signals on different beams may correspond to transmitting signals in different spatial directions. When the text refers to a “beam which is selected” it may refer to a beam index and/or a reference signal (RS) index or identifier, such as a SSB index, or a CSI-RS resource identifier. Thus, selecting a beam may correspond to selecting an SSB associated to an SSB index. Or, selecting a beam may correspond to selecting a CSI-RS associated to a CSI-RS resource identifier.

The actual LTM candidate configuration and its content and/or structure of this IE and/or embedded message may be referred to as an RRC model for the candidate configuration, or simply RRC model. An LTM candidate cell configuration comprises the configuration that the UE needs to operate accordingly when it performs (executes) L1/L2 inter-cell mobility execution to that target candidate cell, upon reception of the lower layer signaling indicating a L1/L2 based inter-cell mobility to that target candidate cell (which becomes the target cell and the current (new) PCell, or an SCell in a serving frequency). The UE may be configured with multiple target candidate cells and a candidate DU generates and sends to the CU multiple configuration(s). The target candidate configuration comprises at least parameters of a serving cell (or multiple serving cells), comprising one or more of the groups of parameters within the IE SpCellConfig (or the IE SCellConfig for a secondary cell). The actual LTM candidate cell configuration the UE receives during the LTM configuration may be a delta signaling to be applied on top of a reference configuration and the actual configuration the UE is to use in the candidate cell upon LTM cell switch is the combination of the LTM candidate cell configuration and the reference configuration (e.g., separately signaled by the network to the UE).

Some examples of how the signaling may be implemented in RRC for the LTM candidate configuration are described as RRC models for L1/L2 based inter-cell mobility, and include the following. One example includes RRC Reconfiguration per candidate cell. In this case the UE receives multiple (a list of) RRC messages (i.e., RRCReconfiguration message) within a single RRCReconfiguration message. Each RRCReconfiguration message identifies a target candidate configuration that is stored by the UE and is applied/used/activated when receiving the lower layer signaling for L1/L2 inter-cell mobility. This model enables full flexibility, as in L3 reconfigurations, for the target node to modify/release/keep any parameter/field in the RRCReconfiguration message, such as measurement configuration, bearers, etc.

Another example includes CellGroupConfig per candidate cell. With this model the UE receives within an RRCReconfiguration a list of CellGroupConfig IEs and each one of them identifies a target candidate configuration. Each CellGroupConfig IE is stored at the UE and is applied/used/activated when receiving the lower layer signaling for L1/L2 inter-cell mobility. This model facilitates the target node to modify/release/keep any parameter/field that is part of a CellGroupConfig 1E while the rest of the RRCReconfiguration message (that is where the CellGroupConfig IE is received by the UE) remain unchanged. This means that, e.g., measurement configuration, bearers, and security remain the same and are not changed by the target node.

Another example includes “K” SpCellConfig or “K” ServingCellConfigCommon, or both per cell. With this model the UE receives either “K” SpCellConfig per cell, “K” ServingCellConfigCommon per “K” cell, or SpCellConfig and “K” ServingCellConfigCommon per cell as a target candidate configuration. This solution provides only minimum flexibility for the target node because only cell-specific parameters (e.g., bandwidth parts, downlink, and uplink configurations) can be modified/released/kept.

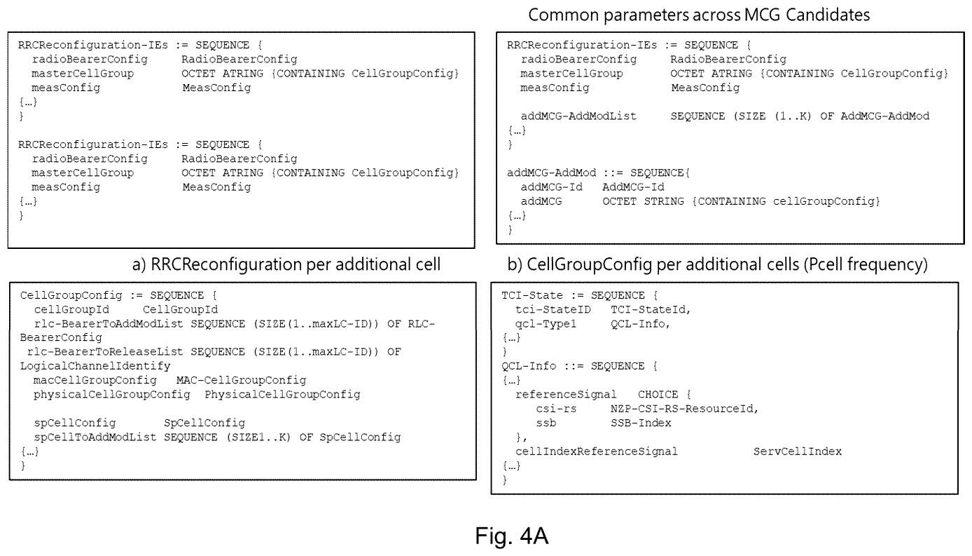

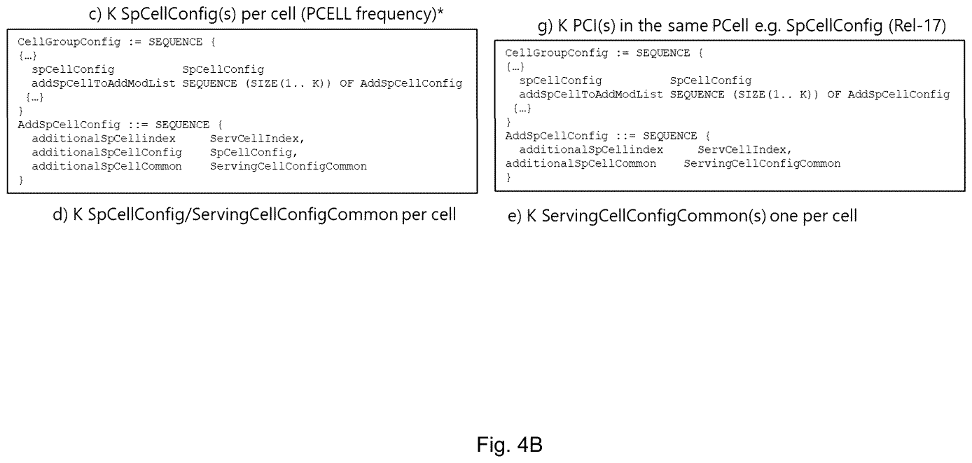

Another example includes “K” PCI in the same PCell. With this model multiple PCIs are configured for the same TCI state configuration where each PCI identify a target candidate configuration. This is approach provides less flexibility because all the parameters/fields used for configuring a target candidate configuration are fixed and only a change of PCI, scrambling Id, and C-RNTI is allowed to the target node. Examples are illustrated in FIGS. 4A and 4B.

FIGS. 4A and 4B illustrate Abstract Syntax Notation (ASN) for six examples of LTM candidate configuration. The L1/L2 inter-cell mobility configuration may correspond to a field and/or information element defined in RRC protocol (e.g., in ASN.1 format) comprising one or more target candidate cell configuration(s). The L1/L2 inter-cell mobility configuration may comprise multiple target candidate cell configuration(s) when the UE is configured with multiple target candidate cell(s) for L1/L2 inter-cell mobility. That L1/L2 inter-cell mobility configuration may be included in an RRCReconfiguration message (as defined in TS 38.331), or an RRC Resume message the UE receives, e.g., during a state transition to RRC_CONNECTED.

The L1/L2 inter-cell mobility configuration may be generated by a CU, e.g. gNB-CU, and include information generated and transmitted from a candidate DU, such as the target candidate cell configuration and/or a measurement configuration indicating the UE to perform measurements on reference signaling (RSs), e.g. SSBs and/or CSI-RS resources, of a target candidate cell, for reporting to the network to assist L1/L2 inter-cell mobility execution decisions.

The first, second, n-th, or (n+1)-th downlink indication that triggers the UE to transmit an uplink message to the LTM candidate cell, for establishing or updating the TA, may correspond to: RRC signaling, such as an RRC message (RRC Reconfiguration) and/or IE and/or field associated to an LTM candidate cell; MAC signaling, such as a MAC CE (e.g., message and/or IE and/or field) associated to the candidate cell; and/or L1 signaling, such as a physical downlink control channel (PDCCH) order, possibly indicating a beam and/or a count value and/or an indication of a power level for transmission of the uplink message to the candidate cell.

The first, n-th or (n+1)-th uplink message transmitted by the UE to the candidate cell for establishing or updating the TA may correspond to: a random access (RA) preamble, a sequence with at least one similar property to a RA preamble, e.g., orthogonal to one another, semi-orthogonal, low correlation properties, etc., and/or a sequence that may be transmitted in an uplink channel of an LTM candidate cell that does not require the UE to be tightly synchronized with the uplink of the LTM candidate cell.

Some examples refer to a TA value, which may refer to a timing advance value. Some examples refer to a TA timer, which may correspond to a time alignment timer.

As used herein, a “TA value” may correspond to an actual TA value to be applied or an indication to a TA value, such as an integer value the UE receives which maps to an actual TA value or shift to be applied for uplink transmissions. One example of a TA value is a timing advance command, which comprises a number of bits indicating an index value TA used to control the amount of timing adjustment that the MAC entity has to apply for a candidate for an uplink transmission on, e.g., sounding reference signal (SRS), physical uplink control channel (PUCCH), physical uplink shared channel (PUSCH), etc.

One set of embodiments includes embodiments for network-controlled fallback TA establishment/update procedure. In a set of embodiments, the UE capable of LTM and configured with at least one LTM candidate cell receives (1) a first downlink indication from a source network node, e.g. source DU (S-DU), which may correspond to a PDCCH order, which may be subsequent to a previous configuration of the LTM candidate cell. In response to the first downlink indication the UE transmits to the LTM candidate cell a first uplink message (e.g., a first RA preamble), wherein the uplink message is transmitted with a first transmission power, and wherein the UE transmits the uplink message to a first uplink resource (e.g., RA resources in time and frequency) associated to the LTM candidate. In some embodiments, the UE selects a first beam, and based on the selected first beam, the UE selects a first uplink resource associated to the first beam for transmitting the first uplink message.

The S-DU, which may also be referred to as a serving DU (with same acronym S-DU), detects when the first uplink message (e.g., RA preamble) is not successfully received at the candidate DU, which is referred to as a preamble transmission failure for TA establishment/update.

In one option, the S-DU detects the preamble transmission failure for TA establishment/update by the expiry of a timer. The S-DU starts the timer when it transmits to the UE the first downlink indication, and while the timer is running the S-DU expects from the candidate DU (C-DU), directly via an interface between the S-DU and C-DU (e.g., E5 interface) and/or the CU (via F1AP interface, from C-DU to S-DU), a message including a TA value calculated by the C-DU based on the reception of the uplink message (RA preamble the UE transmits to the LTM candidate cell). When the timer expires and the S-DU does not receive the message including the TA value, the S-DU considers a preamble transmission failure for TA establishment/update.

In one option, the S-DU detects the preamble transmission failure for TA establishment/update by the reception of a failure indication from the Candidate DU (associated to the candidate cell in which the UE transmits the uplink message), directly via an interface between the S-DU and C-DU (e.g. E5 interface) and/or the CU (via F1AP interface, from C-DU to S-DU). The S-DU transmits to the UE the first downlink indication and expects a message including a TA value calculated by the C-DU based on the reception of the uplink message (RA preamble the UE transmits to the LTM candidate cell). When the S-DU receives a failure indication from the C-DU the S-DU considers a preamble transmission failure for TA establishment/update.

In one option, the S-DU detects the preamble transmission failure for TA establishment/update by the reception of a message from the candidate DU (associated to the candidate cell in which the UE transmits the uplink message), directly via an interface between the S-DU and C-DU (e.g., E5 interface) and/or the CU (via F1AP interface, from C-DU to S-DU), wherein a TA value is absent in the message. The S-DU transmits to the UE the first downlink indication and expects a message including a TA value calculated by the C-DU based on the reception of the uplink message (RA preamble the UE transmits to the LTM candidate cell). When the S-DU receives a message with a TA value absent from the C-DU, the S-DU considers a preamble transmission failure for TA establishment/update.

When the S-DU detects that the first uplink message (e.g., RA preamble) is not successfully received at the C-DU (preamble transmission failure for TA establishment/update), the S-DU transmits to the UE a second downlink indication. This may be referred to as a fallback for TA establishment triggered by the S-DU.

The UE further receives the second downlink indication from the S-DU, based on which the UE transmits a second uplink message (e.g., a second RA preamble) to the candidate cell, wherein the second uplink message (e.g., second RA preamble) transmitted to the candidate cell is transmitted according to: i) an incremented transmission power compared to the first transmission power, or ii) to a second uplink resource (e.g., RA resources in time and frequency) associated to the LTM candidate cell.

In some embodiments, the second downlink indication is associated to the first downlink indication. Based on the second downlink indication being associated to the first downlink indication, the UE transmits the second uplink message (e.g., second RA preamble) to the LTM candidate cell according to: i) an incremented transmission power compared to the first transmission power, or ii) on a second uplink resource (e.g., RA resources in time and frequency) associated to the LTM candidate cell.

In some embodiments, in response to the reception of the second downlink indication, the UE selects a second beam (e.g., SSB or CSI-RS of the LTM candidate cell), and based on the selected second beam the UE selects the second uplink resource (e.g., RA resources in time and frequency) associated to the LTM candidate cell for transmitting the second uplink message.

In some embodiments, the UE further receives a TA value (calculated according to the second uplink signal received at the candidate DU). Different sets of embodiments include different ways to provide the TA value, e.g., during LTM execution/cell switch to the LTM candidate cell (based on the received second uplink signal, the candidate DU was able to calculate a TA value for the UE associated to the LTM candidate cell).

In some embodiments, in an LTM cell switch (LTM execution) to the candidate cell, the UE transmits an uplink message on a PUCCH or PUSCH based on the received TA value.

In some embodiments, the UE transmits the second uplink message to the candidate cell and the S-DU detects another preamble transmission failure for TA establishment/update. In response to the failure detection, the S-DU transmits to the UE a third downlink indication (i.e., fallback for TA establishment triggered by the S-DU).

The UE further receives the third downlink indication from the S-DU based on which the UE transmits a third uplink message (e.g., a third RA preamble) to the candidate cell, wherein the third uplink message (e.g., third RA preamble) transmitted to the candidate cell is transmitted according to: i) an incremented transmission power compared to the second transmission power, or ii) to a third uplink resource (e.g., RA resources in time and frequency) associated to a third beam the UE selects.

In some embodiments, the attempt to establish TA (fallback) is repeated until one or more conditions are fulfilled. The fallback for TA establishment comprises the S-DU transmitting to the UE an (n+1)-th downlink indication after it has provided an n-th downlink indication which led to a preamble transmission failure for TA establishment/update, wherein the (n+1)-th downlink indication indicates to the UE the transmission of an (n+1)-th uplink message, either with an increased or incremented transmission power compared to the transmission power of the n-th uplink message transmission, or indicating that the transmission of an (n+1)-th uplink message is to be towards an (n+1)-th uplink resource (e.g., RA resources in time and frequency) associated to an (n+1)-th beam the UE selects.

The one or more conditions may correspond to: the S-DU detects a preamble transmission failure for TA establishment/update; and/or the S-DU detects that a number of preamble transmission failure for TA establishment/update reaches a maximum value for a given LTM candidate cell and/or UE.

In one option, the maximum value may have been configured by the candidate DU responsible for the LTM candidate cell, which is the C-DU that has configured the uplink resources for the TA establishment and/or TA updating.

In one option, the S-DU increments a counter each time it detects a preamble transmission failure for TA establishment/update (e.g., based on one or more of the solutions proposed above). The S-DU, before transmitting a downlink indication to the UE, checks if the counter reached the maximum value. When the S-DU determines the counter has reached the maximum value, the S-DU does not transmit the downlink indication and considers the TA establishment as failure: referred to as a TA establishment failure.

In other words, when the number of preamble transmission failure for TA establishment reaches its maximum value, the S-DU declares a TA establishment failure.

In one option, the maximum value for the number of preamble transmission failures for TA establishment may have been configured by the candidate DU responsible for the LTM candidate cell, which is the C-DU that has configured the uplink resources for the TA establishment and/or TA updating.

In some embodiments, the S-DU detects that a maximum transmission power for the UE to transmit the uplink message to the LTM candidate cell has been reached. The maximum value may be reached after a number of transmission power increments, after preamble transmission failures for TA establishment.

In one option, the maximum transmission power for TA establishment may have been configured by the candidate DU responsible for the LTM candidate cell, which is the C-DU that has configured the uplink resources for the TA establishment and/or TA updating.

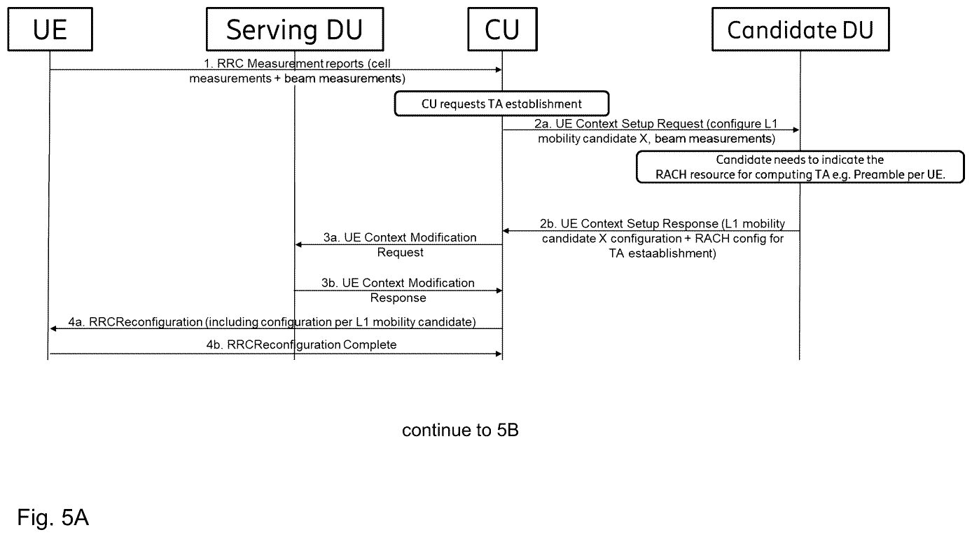

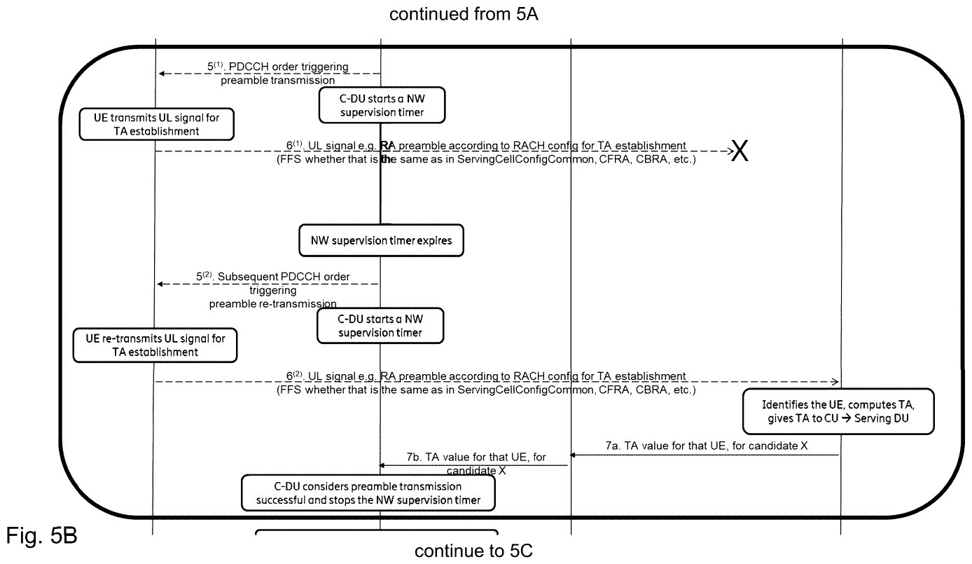

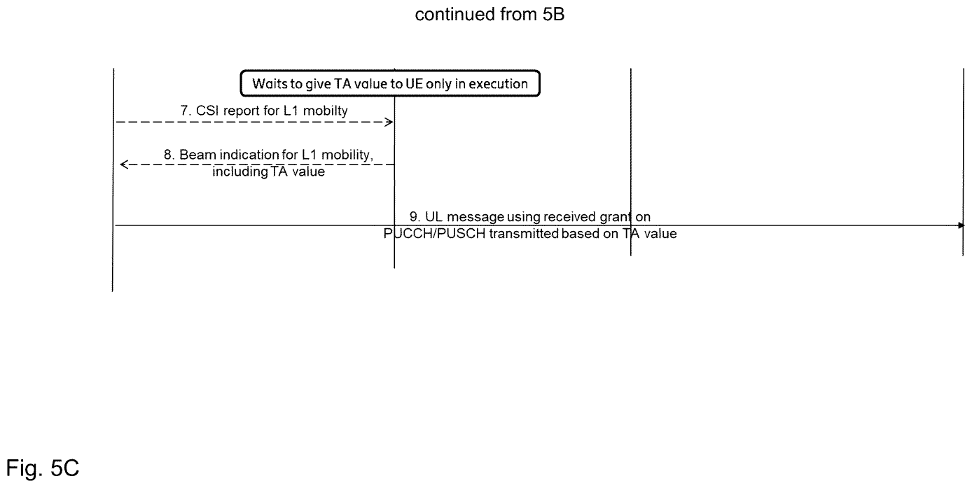

FIGS. 5A, 5B and 5C is a flowchart illustrating an example of steps for the LTM configuration and TA establishment/updating, according to a particular embodiment. The example illustrates failure of RA preamble transmission attempt for TA establishment for LTM. The steps from 1 to 4b comprise the steps for configuring an LTM candidate cell to the UE and configuring the TA establishment and/or updating.

In a set of embodiments, the UE transmits an RRC Measurement Report message to the network (e.g., CU) including measurements on one or more neighbor cells (e.g., cell based reference signal receive power (RSRP), reference signal receive quality (RSRQ) and/or signal to interference and noise ratio (SINR)), in a frequency, wherein a neighbor cell, potentially including beam measurement information (to be later used for configuring the TA establishing procedure). The report is transmitted in response to a network configuration: the UE is configured by the network (e.g., by the CU) to transmit RRC measurement reports (e.g., based on the fulfillment of conditions associated to A3 and/or A5 measurement events, as defined in TS 38.331) including neighbor cells and serving cells.

The UE includes in the RRC Measurement Report (based on the measurement configuration) beam measurement information for the one or more neighbor cells, such as RSRP and/or RSRQ and/or SINR of one or more beams (e.g., of one or more SSBs and/or CSI-RS resources) of a neighbor cell with associated beam identifiers (e.g., SSB indexes and/or CSI-RS resource identifiers) or only beam identifiers, depending on the reporting configuration.

The network (e.g., the CU, gNB-CU) determines to configure the UE with L1/L2 inter-cell mobility. It may determine to request the configuration of one or more neighbor cell(s) included in the RRC measurement report as target candidate cells for L1/L2 inter-cell mobility.

In a set of embodiments, the CU (e.g., gNB-CU, gNB) transmits a request message to a candidate DU (e.g., candidate gNB-DU, via the CU) to configure L1/L2 inter-cell mobility for at least one LTM candidate cell. In one option, the same request is used for a plurality of LTM candidate cell(s) of the same candidate DU. In one option, there is a request per target candidate cell, even if this is a request for cells of the same candidate DU. In one option, the CU transmits requests for multiple candidate DU(s), one per target candidate cell and/or one for multiple target candidate cell(s) in the same candidate DU. A requested target candidate cell may be one of the neighbor cells included in the RRC measurement report the CU may have received.

In one set of embodiments, the CU further requests to the candidate DU the establishment of the TA between the UE and the least one of its target candidate cell(s), for example, by including an indication for that in the request message described above. When the CU determines to configure L1/L2 inter-cell mobility for at least one target candidate cell in a candidate DU, the CU determines that the UE is not synchronized in the uplink with the at least one target candidate cell and decides to request the TA establishment to the candidate DU (responsible for that target candidate cell). That may be referred to as a CU-initiated TA establishment for L1/L2 inter-cell mobility.

In one embodiment, the CU includes a TA establishment request per target candidate cell for which it wants TA to be established, e.g., if they are in different candidate DU(s), or in the same candidate DU but different TRP(s).

In one embodiment, the CU transmits requests for establishing TA to multiple candidate DU(s), one per target candidate cell. In one embodiment, the CU transmits requests for establishing TA for a set of target candidate cells in the same candidate DU.

In one embodiment, the CU further includes in the request to the Candidate DU, the beam measurement information associated to a requested target candidate cell (e.g., beam measurements for one or more SSB of a requested target candidate cell of the candidate DU). That enables the candidate DU to generate an uplink configuration based on the beam measurement information, e.g., physical random access channel (PRACH) preambles mapped to one or more SSB(s) reported as good enough/suitable in terms of RSRP and/or RSRQ and/or SINR.

In one embodiment, the request message from the CU to the candidate DU may correspond to a UE Context Setup Request (F1AP message).

In one embodiment, the request for the establishment of the TA between the UE and the at least one of its target candidate cell(s) is an indication (encoded as an IE) in a UE Context Setup Request (F1AP message).

In one embodiment, the request message from the CU to the candidate DU may correspond to a UE Context Modification Request (F1AP message), e.g., if the candidate DU is the same as the serving DU.

In one embodiment, the request for the establishment of the TA between the UE and the at least one of its target candidate cell(s) is an indication (encoded as an IE) in a UE Context Modification Request (F1AP message), e.g., if the candidate DU is the same as the serving DU.

In one embodiment, the request for the establishment of the TA between the UE and the at least one of its candidate cells includes a request for the S-DU to perform TA establishment fallback(s) when detecting preamble transmissions failures for TA establishment.

In one set of embodiments, when the CU determines to configure LTM for at least one target candidate cell in a candidate DU, this represents for the candidate DU an implicit request that a TA establishment is needed. The candidate DU then decides by itself on whether to provide one TA that is valid for all the L1/L2 inter-cell mobility target candidate cells that is configuring or one TA for each of the L1/L2 inter-cell mobility target candidate cell.

In one set of embodiments, when the CU determines to configure TA establishment for an LTM candidate cell in a candidate DU, this represents for the candidate DU an implicit request that a TA establishment fallback may be needed. The candidate DU may provide in response one or more parameters for the S-DU and/or the CU to control the TA establishment fallback procedure and/or to enable the S-DU to perform the detection of a preamble transmission failures for TA establishment, such as the maximum number of uplink signal (e.g., RA preamble) transmission attempts by a UE for TA establishment is configured by the C-DU responsible for the LTM candidate cell, which is the C-DU that has configured the uplink resources for the TA establishment and/or TA updating. In one option, this is configured per LTM candidate cell. In one option, this is configured per C-DU, i.e., a single value is valid for any LTM candidate cell from that C-DU.

Another parameter may be a maximum number of transmission power increments for the uplink message the UE transmits to the LTM candidate cell being configured. In one option, the transmission power increment (e.g., in dBs) and/or increment step is provided to the UE in the uplink channel configuration for TA establishment. In one option, the transmission power increment (e.g., in dBs) is provided to the S-DU (e.g., via the CU).

Another parameter may be a value for a supervision timer the S-DU monitors to detect an uplink signal transmission failure for TA establishment/update. In one option, the S-DU detects the preamble transmission failure for TA establishment/update by the expiry of the supervision timer.

The S-DU starts the supervision timer when it transmits to the UE the first downlink indication, and while the timer is running the S-DU expects from the candidate DU, directly via an interface between the S-DU and C-DU (e.g., E5 interface) and/or the CU (via F1AP interface, from C-DU to S-DU), a message including a TA value calculated by the C-DU based on the reception of the uplink message (RA preamble the UE transmits to the LTM candidate cell). When the timer expires and the S-DU does not receive the message including the TA value, the S-DU considers a preamble transmission failure for TA establishment/update. That triggers the S-DU to initiate the fallback, i.e., transmit the second downlink indication to the UE to trigger the UE transmit the second uplink signal/message to the C-DU with an incremented power or in another uplink channel resource selected based on a newly selected beam (e.g., SSB or CSI-RS).

Another parameter may include one or more parameters of a time window (C-DU response time window, start time, duration, etc.) the S-DU monitors to detect an uplink signal transmission failure for TA establishment/update. In one option, the S-DU detects the preamble transmission failure for TA establishment/update by the end of the time window.

In other embodiments, the S-DU expects from the candidate DU, directly via an interface between the S-DU and C-DU (e.g., E5 interface) and/or the CU (via F1AP interface, from C-DU to S-DU), a message including a TA value calculated by the C-DU based on the reception of the uplink message (RA preamble the UE transmits to the LTM candidate cell) before the end of the time window. When the time window ends, and the S-DU does not receive the message including the TA value, the S-DU considers a preamble transmission failure for TA establishment/update.

In one set of embodiments, the candidate DU accepts the request for configuring LTM (for at least one LTM candidate cell) and accepts the request to establish TA for at least one LTM candidate cell (or a plurality of LTM candidate cells). In that case, the candidate DU responds to the request from the CU with a response message including the LTM candidate configuration (e.g., for LTM candidate cell X), and including an uplink configuration for establishing the TA between the UE and the LTM candidate cell (e.g., LTM candidate cell X). The UE later receives the uplink configuration (see step 4a).

In one embodiment, the response message also includes an indication that TA establishment has been accepted by the candidate DU, e.g., an indication as an IE of the F1AP message in addition to the uplink configuration. That may be needed so the serving DU does not need to parse RRC fields in the response message to find the uplink configuration and determine the acceptance for the TA establishment. The serving DU may need that if the triggering of the TA establishment later leads to a message from the candidate DU to the serving DU (via the CU) with the TA value.

In one embodiment, the response from the candidate DU may correspond to a UE Context Setup Response (F1AP message).

In one embodiment, the response from the candidate DU may correspond to a UE Context Modification Response (F1AP message), e.g., if the candidate DU is the serving DU, which may be the case when a requested target candidate cell is in the serving DU.

In one embodiment, the uplink configuration for establishing the TA between the UE and the LTM candidate cell (e.g., LTM candidate cell X) is valid for multiple uplink signal/message transmissions to cover the fallback case when the first uplink message is not successfully received in the C-DU.

In one embodiment, the response from the candidate DU includes one or more parameters for the S-DU and/or the CU to control the fallback for TA establishment/updates procedure and/or to enable the S-DU to perform the detection of a preamble transmission failures for TA establishment. The one or more parameters may comprise at least the parameters disclosed in the previous step, e.g., the maximum number of uplink signal (e.g., RA preamble) transmission attempts by a UE for TA establishment, the maximum number of transmission power increments for the uplink message the UE transmits to the LTM candidate cell being configured, the value for a supervision timer the S-DU monitors to detect an uplink signal transmission failure for TA establishment/update, and/or the one or more parameters of a time window (C-DU response time window, start time, duration, etc.) the S-DU monitors to detect an uplink signal transmission failure for TA establishment/update.

Further details about the uplink configuration for establishing the TA between the UE and the target candidate cell are provided later in step 4 and step 5, when the UE receives the uplink configuration.

The uplink configuration for TA establishment may contain one or more parameters for the TA establishment fallback such as: i) the initial transmission power for the uplink signal/message; ii) the power step increment if a fallback is triggered by the network, i.e., when the UE receives the second downlink indication; iii) the association between beams (e.g., SSBs or CSI-RSs) and uplink channel resources (e.g., PRACH occasions and/or time/frequency domain resources for preamble transmissions, RA preambles, etc.).

In one set of embodiments, the candidate DU accepts the request for configuring LTM (for at least one LTM candidate cell) but rejects the request to establish TA for at least one LTM candidate cell (or a plurality of LTM candidate cells). In that case, the candidate DU responds to the request from the CU with a response message including the LTM candidate configuration (e.g., for LTM candidate cell X). That may potentially include an indication of the reject of TA establishment, wherein the indication may comprise the inclusion or absence of a parameter or configuration in the response message (e.g., absence of an F1AP IE, or presence). In this scenario, the serving DU becomes aware that when LTM is to be executed to that target candidate cell, random access may be required with the target candidate during the execution for establishing the TA/uplink synchronization.

In one set of embodiments, the candidate DU rejects the request for configuring LTM and transmits to the CU a message indicating the rejection, potentially including a cause value, e.g. overload.

In one set of embodiments, it is the candidate DU that requests the establishment of a TA for the UE and a target candidate cell for LTM (for at least one target candidate cell). In that case, the candidate DU responds to the request from the CU for L1/L2 inter-cell mobility with a response message including the LTM candidate configuration (e.g., for LTM candidate cell X), and including an uplink configuration for establishing the TA between the UE and the LTM candidate cell (e.g. LTM candidate cell X), which may serve as an indication that the candidate DU is requesting the TA establishment between the UE and one or more of its LTM candidate cell(s). The UE later receives that uplink configuration (see step 4a).

The steps 3a) and 3b) may be used for including re-configuration(s) in the serving cell(s) by the serving DU before the UE is configured with LTM, e.g., to re-configure CSI measurements. In that case, the CU generates an RRC Reconfiguration (e.g., RRCReconfiguration) message including a Cell Group Configuration generated by the serving DU. The CU also includes the LTM configuration with one or more LTM candidate cell configuration(s) and the necessary configuration for the UE to establish the TA with one or more target candidate cells for LTM.

In one embodiment, the S-DU determines the scheduling restrictions that it needs to apply when it expects the UE to transmit the uplink signal/message to the LTM candidate cell for TA establishment/updates and fallback(s) to the TA establishment/updates. In other words, scheduling restrictions refers to the slots/frames and subframes of the serving cell(s) in which the S-DU does not schedule the UE while the UE is transmitting the uplink message(s) to the LTM candidate cell(s) for TA establishment and/or update.

In one set of embodiments, the UE receives an RRC reconfiguration (e.g., RRCReconfiguration message, e.g., from the CU via serving DU) configuring LTM, the message including an LTM configuration configuring one or more LTM candidate cells, i.e., the LTM configuration including one or more LTM candidate cell configuration(s), and an uplink configuration for establishing the TA between the UE and the LTM candidate cell (e.g., candidate cell X), as described in step 2(b).

In one embodiment, the UE receives an uplink configuration for establishing the TA for an LTM candidate cell. The uplink configuration may be for more than a single uplink transmission, if a fallback is needed (when a first uplink message transmission is not successfully received in the C-DU, referred to herein as a preamble transmission failure during TA establishment).

In one embodiment, the UE receives multiple uplink configuration(s) for establishing the TA for multiple LTM candidate cell(s), one per LTM candidate cell.

In one embodiment, the UE receives an indication associated to an LTM candidate cell to indicate that this is a cell for which the UE shall establish TA, e.g., by transmitting an uplink signal/message. The UE may have received at least one uplink configuration for each target candidate cell for which it shall establish TA, based on which the UE transmits a message to the target candidate cell.

In one embodiment, the UE receives an indication associated to an LTM candidate cell to indicate that this is an LTM candidate cell for which a fallback is possible when the UE tries to establish TA.

In one embodiment, the target candidate cells the UE is configured with, for which the UE establishes TA, comprises a subset of the LTM candidate cells. In other words, the UE may be configured with a number ‘N’ of LTM candidates and is configured to establish TA with a number ‘N1’ (with N1<N) candidate cells. The reason may be that some target candidate cells may not require TA to be established, e.g., if they are in the same serving DU and/or are synchronized with one or more serving cells, and/or some of these candidate cells are co-located with one or more of the other serving cell(s), so that the same TA value may be assumed (i.e., some target candidate cells may be assumed to be uplink synchronized with the UE).

In one embodiment, the UE receives an indication of an LTM candidate cell for which the UE does not need to establish TA and, in addition, the UE receives an indication that for the candidate cell the UE may assume the same TA value used for a given serving cell. For example, the UE receives associated to the LTM candidate cell configuration a serving cell index of one of its configured serving cells. Then, when the UE receives the LTM cell switch command, for LTM execution (e.g., MAC CE including an indication of a candidate cell configuration) the UE determines that this is a cell for which a TA value to be considered is the same as the TA value for the indicated serving cell, and the UE applies that TA value accordingly when accessing the LTM candidate cell.

In one embodiment, the UE receives an indication of an LTM candidate cell for which the UE does not need to establish TA and, in addition, the UE receives a TA value for the candidate cell. For example, the UE receives associated to the target cell configuration a serving cell index of one of its configured serving cells. Then, when the UE receives the LTM cell switch command (e.g., MAC CE including an indication of a candidate cell configuration) the UE applies that TA value provided in the LTM cell switch command.

In one embodiment, the UE receives an indication of an LTM candidate cell for which the UE does not need to establish TA and, in addition, the UE receives the TA value 0 for the candidate cell. For example, the UE receives associated to the candidate cell configuration a serving cell index of one of its configured serving cells. Then, when the UE receives the LTM cell switch command (e.g., MAC CE including an indication of a candidate cell configuration) the UE applies that TA value 0 provided in the LTM cell switch command.

In one embodiment, the UE receives an indication of an LTM candidate cell for which the UE does not need to establish TA (e.g., absence of the uplink configuration for TA establishment or an explicit indication in the LTM candidate cell configuration) and, in addition, the UE receives an indication that for the candidate cell the UE may require random access with the LTM candidate cell upon reception of the LTM cell switch command (e.g., MAC CE including an indication of a candidate cell configuration).

In one embodiment, the UE receives the uplink configuration for establishing the TA between the UE and the LTM candidate cell (e.g., candidate cell X) which may comprise an indication (e.g., an uplink configuration for an LTM candidate cell) based on which the UE transmits one or more uplink signal(s) or message(s) to the LTM candidate cell (e.g., one or more RA or PRACH preamble(s)), enabling the candidate DU to establish the TA and to indicate the TA value to the CU and the serving DU. The uplink configuration may be valid for multiple uplink transmissions from the UE to establish the TA, to cover the fallback case when the C-DU does not successfully detect the uplink message transmitted by the UE.

In one embodiment, the UE receives the uplink configuration for establishing the TA between the UE and the LTM candidate cell (e.g., candidate cell X) (e.g., as a field, parameter, set of parameters and/or fields, IE, etc.) within the LTM candidate configuration (e.g., for candidate cell X, in an RRCReconfiguration container, and/or an IE CellGroupConfig and/or an SpCell configuration). That may be, e.g., one or more parameters in a random access configuration of the SpCell configuration in the target candidate configuration. The RA configuration may be valid for multiple uplink transmissions from the UE to establish the TA to cover the fallback case when the C-DU does not successfully detect the uplink message transmitted by the UE.

In one embodiment, the UE receives the uplink configuration for establishing the TA between the UE and the LTM candidate cell (e.g., candidate cell X) configured as an IE and/or field and/or set of IEs and fields in the LTM configuration, which may correspond to an IE for configuring one or more LTM candidate cell(s) for LTM.

In one option, the uplink configuration is set for an LTM candidate cell, e.g., a candidate cell has its uplink configuration for TA establishment.

In one option, the uplink configuration is set for a set of LTM candidate cell(s). The uplink configuration may still be for a given LTM candidate cell, as the parameters are defined for a given uplink channel of a given cell, but when the UE establishes TA for that single cell, it is valid for a set of cells, which may be possible if multiple cells are of the same candidate DU and/or the same TRP and/or have some common transceiver properties and/or are uplink synchronized.

In one embodiment, the UE receives the uplink configuration for establishing the TA between the UE and the LTM candidate cell (e.g., candidate cell X) configured as an IE and/or field and/or set of IEs and fields in the RRC Reconfiguration message in which the UE receives the LTM configuration.

In one embodiment, the UE receives the uplink configuration for establishing TA between the UE and the LTM candidate cell (e.g., candidate cell X) comprising the configuration of an uplink signal/message and/or the configuration of the channel(s) for the UE to transmit the uplink signal/message (to be received at the candidate DU). The uplink channel configuration (e.g., available time and/or frequency domain resources) may be valid for multiple uplink transmissions from the UE to establish the TA to cover the fallback case when the C-DU does not successfully detect the uplink message transmitted by the UE.

The uplink signal/message may correspond to a random-access preamble (or an equivalent sequence defined in the physical layer) indicated by a random access preamble index (e.g., ra-PreambleIndex of IE INTEGER (0 . . . 63)) in the uplink configuration.

The uplink configuration may further include at least one beam identifier/index associated to an uplink signal, such as an SSB index and/or a CSI-RS resource identifier.

For example, when the uplink signal corresponds to a preamble, the uplink configuration may comprise at least one TA establishment resource, as the pair (ssb of IE SSB-Index, ra-PreambleIndex or IE INTEGER (0 . . . 63)). The uplink configuration may comprise multiple of these pairs, because the candidate DU is not aware which SSB and/or CSI-RS resource the UE will choose for establishing the TA. The configured beam(s), e.g., SSBs may be referred to as candidate beams for TA establishment.

In the example below, the UE is provided with a list of TA establishment resource(s) for an LTM candidate cell, wherein each resource has a preamble index and an SSB index associated:

| | |
|---|---|
| TA-Config : : = | SEQUENCE { |
| [...] | |
| candidateBeamList | SEQUENCE (SIZE (1 . . FFS) ) OF TA-SSB- |
| Resource OPTIONAL, | |
| [...] | |
| } | |
| [...] | |
| TA-SSB-Resource : : = | SEQUENCE { |
| ssb | SSB-Index, |
| ra-PreambleIndex | INTEGER (0. . 63) , |
| . . . | |
| } | |

In another example, the UE is provided with a list of TA establishment resource(s) for an LTM candidate cell, wherein each resource has a preamble index and a CSI-RS resource associated. In addition to the pair, there is also per resource a random-access occasion list. These are RA occasions that the UE shall use when performing TA establishment (including possible subsequent transmissions of preambles in case a fallback is needed, when there is a detection of a preamble transmission failure) with an LTM candidate cell upon selecting the candidate beam identified by the corresponding CSI-RS.

| TA-CSI-Resource : : = | SEQUENCE { |
|---|---|
| csi-RS | NZP-CSI-RS-ResourceId, |
| ra-PreambleIndex | INTEGER (0 . . 63) |
| OPTIONAL, -- Need R | |
| ra-OccasionList | SEQUENCE (SIZE (1 . . maxRA- |
| OccasionsPerCSIRS) ) OF INTEGER | |
| (0. .maxRA-Occasions-1) OPTIONAL, -- Need | |
| R | |
| . . . | |
| } | |

The candidate DU determines which beam identifier(s)/indexes of an LTM candidate cell to configure for TA establishment based on beam measurement information (e.g., measurement information on SSBs and/or CSI-RS of a target candidate cell), obtained from the CU in/with the request of LTM. The network (e.g., CU) may have configured the UE to report beam measurement information as it intended to trigger the UE to establish TA with an LTM candidate cell when it configures the UE with LTM. For example, for a neighbor cell included in the measurement report, the UE may have reported SSB index X and SSB index Y and their respective RSRP values (e.g., above a threshold in the reporting configuration), indicating these are suitable beams in the neighbor cell.

The uplink configuration may further include one or more of the following parameters: Root Sequence Index: PRACH root sequence index for TA establishment in LTM, to be possibly defined in TS 38.211. This may be a field, e.g., rootSequenceIndex of IE INTEGER (0 . . . 137)).

RSRP threshold for SSB: L1-RSRP threshold used for determining whether a candidate beam may be used by the UE to attempt contention free random access to establish TA with an LTM candidate cell. This may be a field rsrp-ThresholdSSB.
SSB(s) per RACH occasion(s): Number of SSBs per RACH occasion for contention free TA establishment with an LTM candidate cell. This may be the field ssb-perRACH-Occasion of IE ENUMERATED {oneEighth, oneFourth, oneHalf, one, two, four, eight, sixteen}.
RA SSB occasion mask index: Explicitly signaled PRACH Mask Index for RA Resource selection, valid for one or more SSB resources. This may be the field ra-ssb-OccasionMaskIndex.
Subcarrier spacing for MSG1: Subcarrier spacing for contention free TA establishment with the target candidate cell, e.g. values 15 kHz or 30 kHz (FR1), and 60 kHz or 120 kHz (FR2). This may be the parameter msg1-SubcarrierSpacing of IE SubcarrierSpacing.
A triggering condition in the form of a measurement event A2, A3, A4 or A5 that is to be fulfilled before triggering TA establishment with an LTM candidate cell.

The uplink configuration may correspond to contention-free resource and/or dedicated resources, so that when the candidate DU receives a preamble in an uplink slot in a frequency resource it is able to determine which UE it has been configured for and/or which serving DU/CU is serving that UE.

The uplink configuration may further include one or more parameters of a random access configuration, such as RACH parameters such as preamble(s), time and frequency resources for a PRACH, and/or one or more parameters, fields and/or IEs within the IE RACH-Config, RACH-ConfigCommon, RACH-ConfigDedicated, RACH-ConfigGeneric as defined in TS 38.331. This may be special RACH configuration containing only the transmission parameters, i.e., no random access response parameters, as the UE is not expected to receive a response from the target candidate in response to the preamble transmission.

In one embodiment, the UE receives the uplink configuration for establishing TA between the UE and the LTM candidate cell (e.g., candidate cell X) comprised within one or more parameters in the beam failure recovery (BFR) configuration of the target candidate cell (e.g., IE BeamFailureRecoveryConfig) associated to the uplink bandwidth part (BWP) which may be assumed active upon L1/L2 inter-cell mobility execution. Using that, the candidate DU may distinguish preambles and RACH message for the TA establishment from other preambles and RACH attempts. BFR is anyways not used for that UE before the target candidate is accessed during L1/L2 inter-cell mobility execution, which makes this possible without the need of a further detailed configuration.

In one embodiment, the UE obtains the uplink configuration, at least partially, from a random access configuration of the LTM candidate configuration, e.g., the RACH configuration of the SpCell configuration of the LTM candidate configuration. The UE may receive a time/frequency resource partitioning for PRACH and/or a preamble partitioning indicating a subset of RACH resource used for that purpose, so that the candidate DU is aware that a preamble transmitted shall not be responded in a RAR, but the TA shall be calculated and provided to a serving DU. In that sense, the candidate DU may provide different PRACH resource partitioning for UE(s) in different serving DU(s), in case of multiple requests.

In one embodiment, the uplink configuration for TA establishment contains one or more parameters for the fallback of the TA establishment/updates if a fallback is necessary and triggered by the network (e.g., by the second downlink indication). For example: i) the initial transmission power for the uplink signal/message; ii) the power step increment if a fallback is triggered by the network, i.e., when the UE receives the second downlink indication; iii) the association between beams (e.g., SSBs or CSI-RSs) and uplink channel resources (e.g., PRACH occasions and/or time/frequency domain resources for preamble transmissions, RA preambles, etc.).

The UE transmits an RRC reconfiguration complete (e.g., RRCReconfigurationComplete) message after it successfully applies the RRC reconfiguration (e.g., RRCReconfiguration) message.

In one set of embodiments, the UE receives an RRC reconfiguration (e.g., RRCReconfiguration) message (e.g., from the CU via serving DU), the message including an uplink configuration for establishing the TA between the UE and the LTM candidate cell (e.g., candidate cell X) after the UE has received an LTM configuration configuring one or more LTM candidate cells. This means that the CU or serving DU may request the establishment of the TA to the candidate DU after LTM has been configured at the UE. For example, the S-DU and/or CU may trigger the TA establishment when there is some certainty that there will be an LTM cell switch towards that candidate DU. This also means that the uplink configuration is received by the serving DU before sending the lower layer switching command to the UE for executing the LTM. The UE transmits an RRCReconfigurationComplete message after it successfully applies the RRCReconfiguration message.

According to a set of embodiments, the S-DU is responsible for monitoring whether the UE transmission of the uplink message/signal to the candidate DU for TA establishment is successful. In other words, the S-DU determines whether there is a preamble transmission failure for TA establishment/update. There are different options on how to define these failure monitoring steps.

In one option, the S-DU detects the preamble transmission failure for TA establishment/update by the expiry of a timer (supervision timer). The S-DU starts the supervision timer when it transmits to the UE the first downlink indication (e.g., the RRC Reconfiguration including the LTM configuration or a subsequent PDCCH order transmitted after that RRC Reconfiguration including the LTM configuration), and while the timer is running the S-DU expects from the candidate DU, directly via an interface between the S-DU and C-DU (e.g., E5 interface) and/or the CU (via F1AP interface, from C-DU to S-DU), a message including a TA value calculated by the C-DU based on the reception of the first uplink message (RA preamble the UE transmits to the LTM candidate cell). When the message including the TA value is received, the S-DU stops the timer and considers the TA establishment procedure successful. When the timer expires and the S-DU does not receive the message including the TA value, the S-DU considers a preamble transmission failure for TA establishment/update.

In one option, the S-DU detects the preamble transmission failure for TA establishment/update at the end of a time window (whose properties are a starting point and a duration and/or an end point in time). The S-DU expects from the candidate DU, directly via an interface between the S-DU and C-DU (e.g., E5 interface) and/or the CU (via F1AP interface, from C-DU to S-DU), a message including a TA value calculated by the C-DU based on the reception of the first uplink message (RA preamble the UE transmits to the LTM candidate cell). When that message including the TA value is received within the time window, the S-DU considers the TA establishment procedure successful. When the time window ends and the S-DU did not receive the message including the TA value, the S-DU considers a preamble transmission failure for TA establishment/update.

In one option, the properties of the time window are the same as the properties of a random access response (RAR) time window configured as part of the uplink channel configuration for TA establishment provided to the UE.

In one option, the S-DU detects the preamble transmission failure for TA establishment/update by the reception of a failure indication from the candidate DU (associated to the candidate cell in which the UE transmits the uplink message), directly via an interface between the S-DU and C-DU (e.g., E5 interface) and/or the CU (via F1AP interface, from C-DU to S-DU). The S-DU transmits to the UE the first downlink indication to the UE (e.g., the RRC Reconfiguration including the LTM configuration or a subsequent PDCCH order transmitted after that RRC Reconfiguration including the LTM configuration), and expects a message including a TA value calculated by the C-DU based on the reception of the first uplink message (RA preamble the UE transmits to the LTM candidate cell). When that message including the TA value is received, the S-DU considers the TA establishment procedure successful. When the S-DU receives a failure indication from the C-DU (e.g., via the CU), the S-DU considers a preamble transmission failure for TA establishment/update.

In one option, the failure indication from the C-DU to the S-DU (e.g., via the CU) may correspond to the message with a TA value absent, so the S-DU considers a preamble transmission failure for TA establishment/update.

In one set of embodiments, the UE receives a subsequent message to trigger the UE to transmit the first uplink signal/message to the LTM candidate cell. The subsequent message may correspond to e.g. a MAC CE, a PDCCH order, a DCI, an RRC message, received by the UE after the RRC reconfiguration (e.g., RRCReconfiguration) configuring LTM. The RRC reconfiguration configuring LTM may have also included the indication for TA establishment for that LTM candidate cell, or that indication is within the subsequent message. The subsequent message is shown in FIG. 5B as step 5.

The UE receiving a subsequent message as above may be useful in a scenario in which the candidate DU accepts the TA establishment from the CU, but the serving DU has some freedom to trigger the TA establishment to the UE when an interruption time would not be as critical, because to transmit the first uplink signal to the target candidate the UE may need to stop listening to the serving cell(s)/serving DU. Upon reception of the subsequent message (e.g., PDCCH order), the UE transmits the first uplink signal/message based on the previously received uplink configuration for the TA establishment in LTM configuration.

The first downlink indication may correspond to the subsequent message (e.g., MAC CE, PDCCH order, DCI, RRC message), as exemplified in step 5.

In one embodiment, the subsequent message (first downlink indication) includes one or more indications related to how the UE performs the transmission of the first uplink message/signal to the LTM candidate cell, e.g., parameters of the RA preamble transmissions and/or RA resource(s). The one or more indications may correspond to a pointer or indication to one or more parameters in the uplink configuration for establishing the TA between the UE and the LTM candidate cell (e.g., candidate cell X), as described in step 2(b).

In one option, the UE may receive in the uplink configuration a set of RA preamble(s) e.g. p1, p2, p3, . . . , pK. Thus, the subsequent message (downlink indication) may indicate one or more of the configured RA preambles, e.g. p3 and p2. Based on the indication(s), the UE knows which preambles it may transmit/select/use for transmission to the LTM candidate cell.

In one option, the UE receives in the subsequent message an RA preamble index (e.g., ra-PreambleIndex) of the LTM candidate cell, explicitly provided by PDCCH.

In one option, the UE may receive in the uplink configuration a set of RA resource(s), like sequence and/or time domain resources and/or frequency domain resources, associated to an RS index or identifier, e.g. SSB index. Thus, the subsequent message (downlink indication) may indicate one or more of the configured RA resources, e.g., by indicating one or more SSBs. Based on that, the UE knows which SSBs (and consequently which RA resources) it may select for transmission to the LTM candidate cell.

In one option, the UE may receive in the uplink configuration a set of RS(s) indexes, e.g., SSB indexes. Thus, the subsequent message (downlink indication) may indicate one or more of the SSB indexes associated to one or more RA resources, e.g., by indicating one or more SSBs. Based on that, the UE knows which SSBs (and consequently which RA resources) it may select for transmission to the LTM candidate cell.

This scheme of a subsequent message may also be used for the TA update/maintenance mechanism, shown in the following sections.

Some embodiments include steps for failure detection of the first uplink preamble at the C-DU and network-centric fallback. The steps from 1 to 4b described above are the steps for configuring one or more LTM candidate cells to the UE and configuring the TA establishment and/or updating for at least one cell.

In the following steps, the sets of embodiments cover the cases where the uplink signal/message for TA establishment is not successfully detected by the C-DU and the actions from the different nodes (e.g., UE, S-DU, C-DU, CU) in response to that, in what is referred to herein as a fallback procedure for TA establishment/update.

In a set of embodiments (see 6(1) in FIG. 5B), the UE transmits the first uplink signal/message (e.g., PRACH preamble, RA preamble) to an LTM candidate cell (for which the UE needs to establish TA) based on the uplink configuration described in Step 4.

In one set of embodiments, the UE transmits the first uplink signal in response to the reception of the RRC reconfiguration (e.g., RRCReconfiguration) configuring LTM (including the indication for TA establishment for that LTM candidate cell), as shown as in step 4 (a) in FIG. 5A.

In this case, the first downlink indication may correspond to the RRC reconfiguration (e.g., RRCReconfiguration) message configuring LTM.

This may be the case in the first uplink message, while subsequent messages may be used in the case of fallback for TA establishment or TA updates.

In one set of embodiments, the UE transmits the first uplink signal in response to the reception of the subsequent message (e.g., MAC CE, PDCCH order, DCI, RRC message), received by the UE after the RRCReconfiguration configuring LTM for that LTM candidate cell. The subsequent message is shown in FIG. 5B as step 5(1).

In this case, the first downlink indication may correspond to the subsequent message (e.g., MAC CE, PDCCH order, DCI, RRC message).

In one embodiment, the uplink configuration is associated to a validity time (e.g., modeled as a time window, timer, etc.), so that the serving DU and/or the CU has a limited time to transmit the subsequent message to the UE. That may be used to limit the usage of the uplink resources reserved for TA establishment by the C-DU, e.g., in case these are UE dedicated/contention-free resources.

The validity time may be important when a fallback is triggered by the S-DU. For example, when the C-DU allocates uplink resources for the TA establishment, and a fallback is performed, there are multiple uplink transmissions to the C-DU/LTM candidate cell, which means that resources may need to be used for longer than when a single uplink transmission is allowed. Thus, the validity time may be something also indicated from the C-DU to the S-DU, which controls the fallback for the TA establishment/updates.

In one embodiment, upon triggering the TA establishment with an LTM candidate cell (e.g., by reception of the subsequent message and/or first downlink indication and/or the transmission of the first uplink message), the UE initiates a procedure (e.g., in response to the first downlink indication, like the subsequent message of the RRC Reconfiguration with the LTM configuration). Some steps in such procedure might be considered like some steps performed in a RA procedure, but there are some differences: for example, in the procedure for TA establishment part of the method disclosed herein, the UE transmits the first uplink message (e.g., a first RA preamble) and does not expect a RAR from the LTM candidate cell in response to a RA preamble transmitted in the LTM candidate cell. The procedure for TA establishment (in particular the initial attempt and possibly some relevant steps for the fallback when needed) comprises one or more of the following steps.

Some embodiments include performing one or more measurements on beams, wherein a “beam” may also be referred to as a spatial direction in which reference signals and/or channels are being transmitted by the network, e.g., by the S-DU or C-DU. In one option, the UE performing a measurement on a beam corresponds to the UE performing a measurement on a reference signal and/or synchronization signal associated to a spatial direction in which that reference signal and/or synchronization signal is being transmitted. A beam may be associated to a beam identifier (ID), which may be encoded by the reference signal or synchronization signal transmitted in the spatial direction associated to that beam.

Some embodiments include performing one or more measurements on SSBs and/or CSI-RS resources of the target candidate cell for which the UE needs to establish the TA, e.g. SSB RSRP measurement(s) for one or more SSBs, such as SS-RSRP of SSB index=1, SS-RSRP of SSB index=2, . . . , SS-RSRP of SSB index=k; e.g. CSI-RS RSRP measurement(s) for one or more CSI-RS(s).

Some embodiments include performing an uplink channel resource selection, e.g., RACH resource selection, associated to an SSB and/or CSI-RS resource of the LTM candidate cell for which the UE needs to establish the TA. For example, the UE selects an SSB or CSI-RS resource for which a measurement is above a threshold (possibly configured in the uplink configuration), e.g. SSB RSRP>rsrp-ThresholdSSB; and the UE selects an uplink channel resource (e.g., time/frequency resources and preamble) for TA establishment associated to the selected SSB, wherein the association is also part of the uplink configuration.

Some embodiments include transmitting the first uplink signal/message (e.g., selected preamble based on the selected SSB) in the selected RA resource to the LTM candidate cell, wherein the first uplink message is transmitted with a first transmission power, wherein the selected RA resource corresponds to a first uplink resource (e.g., RA resources in time and frequency).

In one option, the first uplink resource that is selected is associated to the first beam the UE has selected (e.g., selected SSB), for example, based on one or more beam measurements the UE performs.

In one option, the UE sets a variable for the preamble transmission to the signaled preamble, e.g., set the variable PREAMBLE_INDEX to the signaled ra-PreambleIndex. In one option, the UE selects the SSB signaled by the network, e.g., signaled by PDCCH. In one option, the UE selects an SSB with a measurement, such as SS-RSRP (as defined in TS 38.215), above a measurement threshold, e.g. rsrp-ThresholdSSB, amongst the associated SSBs.

In one option, the UE sets the PREAMBLE_INDEX to a ra-PreambleIndex corresponding to the selected SSB. In one option, the UE selects the CSI-RS signaled, e.g., by PDCCH. In one option, the UE selects a CSI-RS resource with CSI-RSRP (as defined in TS 38.215) above rsrp-ThresholdCSI-RS amongst the associated CSI-RSs. In one option, the UE sets the PREAMBLE_INDEX to a ra-PreambleIndex corresponding to the selected CSI-RS.

In one option, the UE selects an SSB and when an SSB is selected, the UE determines the next available PRACH occasion from the PRACH occasions corresponding to the selected SSB permitted by the restrictions given by a configuration (e.g., the ra-ssb-OccasionMaskIndex, part of the uplink configuration for TA establishment) if configured or indicated by PDCCH (the MAC entity at the UE selects select a PRACH occasion randomly with equal probability amongst the consecutive PRACH occasions, corresponding to the selected SSB).

In one option, the UE (e.g., the MAC entity at the UE) accounts for the possible occurrence of measurement gaps when determining the next available PRACH occasion corresponding to the selected SSB.

In one option, the UE selects a CSI-RS and determines the next available PRACH occasion from the PRACH occasions in a configured RA occasion list/set (e.g., ra-OccasionList) corresponding to the selected CSI-RS. The UE (e.g., the MAC entity at the UE) selects a PRACH occasion randomly with equal probability amongst the PRACH occasions occurring simultaneously but on different subcarriers, corresponding to the selected CSI-RS.

In one option, the UE (e.g., the MAC entity at the UE) accounts for the possible occurrence of measurement gaps when determining the next available PRACH occasion corresponding to the selected CSI-RS.

In one option, when the UE determines if there is an SSB with SS-RSRP above rsrp-ThresholdSSB or a CSI-RS with CSI-RSRP above rsrp-ThresholdCSI-RS, the UE uses the latest unfiltered L1-RSRP measurement.

In one option, the UE does not maintain a counter for preamble transmissions (e.g., PREAMBLE_TRANSMISSION_COUNTER) which would be maintained in a RA procedure. The reason is that this should be controlled by the network (e.g., S-DU), which controls the need for a fallback procedure (i.e., RA preamble re-transmissions with power ramping and/or beam/SSB/CSI-RS re-selection without reaching a maximum number of preamble transmissions attempts). Thus, in this network controlled fallback, it is the network (e.g., S-DU) that monitors the number of preamble transmissions, e.g., by controlling a preamble transmission counter, which is incremented each time the UE is indicated to transmit a RA preamble for the TA establishment for LTM.

In one option, the UE sets the first transmission power (PREAMBLE_RECEIVED_TARGET_POWER) by adding up one or more of: a value provided in the uplink configuration (e.g., preambleReceivedTargetPower); a delta value which depends on the RA preamble format (e.g., 0 dB for preamble format 0), e.g. DELTA_PREAMBLE; and/or a value indicated in the downlink indication or an indication in the downlink indication which enables the UE to derive a value that is to be added to the first transmission power.

In one option, the UE (e.g., the MAC entity at the UE) instructs the physical layer at the UE to transmit the selected or indicated RA preamble using the selected PRACH occasion, and the first transmission power (e.g., PREAMBLE_RECEIVED_TARGET_POWER).

The method is also applicable when an LTM candidate cell has a single beam, such as when an LTM candidate cell has a single SSB associated to its physical cell identity. In that case, the step of selecting a beam (e.g., selecting an SSB or CSI-RS of that LTM candidate cell) for RA resource selection may be skipped.

In a set of embodiments, the candidate DU does not successfully receive the first uplink message/signal (e.g., a PRACH preamble). Or, in other words, the C-DU detects that the first uplink message was not successfully received, i.e., it detects a failure in the transmission attempt. Consequently, the C-DU is not able to calculate a timing advance value for the UE and at least one LTM candidate cell. Thus, it may be said that the C-DU detects that it is not possible to calculate the TA value, and may have a cause value associated (e.g., detection timer expired, weak signal strength making identification of the uplink signal/preamble not possible, etc.) and possibly indicated to the S-DU, e.g., uplink signal transmission attempt failed. There may be different options for the C-DU to determine that the first uplink message/signal is not successfully detected.

In one option, the C-DU starts a timer (e.g., preamble reception timer) when it transmits to the CU and/or S-DU the uplink configuration for TA establishment (e.g., step 2(b), transmission of the UE Context Setup Response) and, when a configured RA preamble for TA establishment is not received while the preamble reception timer is running, the C-DU considers the preamble transmission attempt as failed. In other words, the preamble transmission attempt is considered as failed in the C-DU when the preamble reception timer expires. When the RA preamble is received while that preamble reception timer is running, the timer is stopped because the attempt is considered successful.

In response to a preamble transmission failure detection, the C-DU may transmit a message to the CU and/or the S-DU, to indicate the preamble transmission failure detection (in one sub-option that may provide further input enabling the fallback, e.g., new SSBs and/or parameters settings for further preamble re-transmissions). That may be the same message which may optionally contain a TA value, but when that field is empty it indicates that the C-DU was not able to calculate a TA value because the RA preamble was not properly received.

In a set of embodiments, the S-DU detects that the first uplink message/signal (e.g., a PRACH preamble) is not successfully received at the C-DU, e.g., by reception of a failure indication from the C-DU, the end of a time window or by the expiry of a supervision timer (which the S-DU may have started when it has transmitted to the UE the first downlink indication). In FIG. 5C, the option shown is based on a supervision timer at the S-DU, which is started in step 5(1) or 4(a) (depending on which of these messages triggers the UE to transmit the uplink message/signal to the LTM candidate cell for LTM establishment). The RA preamble transmission attempt failure is detected when the supervision timer expires when the S-DU does not receive a message from the C-DU (e.g., via the CU) including the expected timing advance value, or the S-DU receives the expected message from the C-DU (e.g., via the CU) but not including the expected timing advance value (one advantage of that is that the S-DU may detect the failure faster, without the need to wait for the timer to expire).

At Step 5(2), in a set of embodiments, the S-DU transmits to the UE a second downlink indication, in response to the detection that the C-DU does not successfully receive the first uplink message/signal (e.g., a PRACH preamble), i.e. in response to a failed attempt to transmit the RA preamble to the TLM candidate cell. That may be detected at the S-DU, for example, upon the expiry of the supervision timer, as described in the previous step. The S-DU transmits the second downlink indication to the UE, triggering the UE to transmit a second uplink message/signal to the LTM candidate cell, for the TA establishment. That may be seen as a fallback triggered by the S-DU upon detecting the failed attempt to transmit RA preamble by the UE.

Some of the steps of 5(2) may be like the steps in 5(1), e.g., assuming that the second downlink indication corresponds to a subsequent message, like a PDCCH order.

In one option, the S-DU provided the RRC Reconfiguration with the LTM configuration to trigger at the UE the transmission of the first uplink signal/message, so that the first uplink indication corresponds to the RRC Reconfiguration; while the subsequent message (e.g., PDCCH order) is used to trigger the UE to transmit the second uplink signal/message (i.e., the second downlink indication corresponding to the subsequent message).

In one option, the S-DU provided the RRC Reconfiguration with the LTM configuration for configuring the TA establishment/updates but it is a subsequent message (e.g., first PDCCH order) that triggers at the UE the transmission of the first uplink signal/message, so that the first downlink indication corresponds to a first subsequent message after the RRC Reconfiguration; while a second subsequent message (e.g., a second PDCCH order) is used to trigger the UE to transmit the second uplink signal/message (i.e., the second downlink indication corresponding to a second subsequent message, e.g., second PDCCH order for the RA preamble re-transmission).

In one set of embodiments, the second downlink indication (e.g., a second subsequent message (e.g., a second PDCCH order) includes one or more indications related to how the UE performs the transmission of the second uplink message/signal to the LTM candidate cell, e.g., parameters of the RA preamble transmissions and/or RA resource(s). The one or more indications may correspond to a pointer or indication to one or more parameters in the uplink configuration for establishing the TA between the UE and the LTM candidate cell (e.g., candidate cell X), in particular for this re-attempt to transmit a RA preamble for TA establishment for LTM, as described in step 2(b).

In one option, the UE may receive in the uplink configuration a set of RA preamble(s) e.g. p1, p2, p3, . . . , pK. Thus, the subsequent message (downlink indication) may indicate one or more of the configured RA preambles, e.g. p3 and p2. Based on the indication(s), the UE knows which preambles it may transmit/select/use for transmission to the LTM candidate cell. This may be the same uplink configuration the UE receives when it is configured for TA establishment.

In one option, the UE receives in the subsequent message an RA preamble index (e.g., ra-PreambleIndex) of the LTM candidate cell explicitly provided by PDCCH. In one option, the UE may receive in the uplink configuration a set of RA resource(s), like sequence and/or time domain resources and/or frequency domain resources, associated to an RS index or identifier, e.g. SSB index. Thus, the subsequent message (downlink indication) may indicate one or more of the configured RA resources, e.g., by indicating one or more SSBs. Based on that, the UE knows which SSBs (and consequently which RA resources) it may select for transmission to the LTM candidate cell.

In one option, the UE may receive in the uplink configuration a set of RS(s) indexes, e.g., SSB indexes. Thus, the subsequent message (downlink indication) may indicate one or more of the SSB indexes associated to one or more RA resources, e.g., by indicating one or more SSBs. Based on that, the UE knows which SSBs (and consequently which RA resources) it may select for transmission to the LTM candidate cell.

In one option, the UE may receive in the uplink configuration one or more LTM candidate cell ID(s) in which the UE should sent the second uplink message/signal. If multiple LTM candidate cell IDs are provided to the UE, each LTM candidate ID may be mapped to a set of RA preambles, RA preamble indexes, RA resources or RS(s) indexes (e.g., SSB indexes). Based on this, the UE knows which parameters to use for each LTM candidate cell that is received. The UE may send one second uplink message/signal to each of the received LTM candidate cells or it may select only one LTM candidate cell from the set of those configured to which to send the first uplink message/signal.

Some embodiments include one or more parameters or indication based on which the UE determines how to set the second transmission power for transmitting the second uplink message/signal, e.g., if the UE selects the same beam/SSB/CSI-RS selected on the previous preamble transmission attempt which has failed.

This scheme may also be used for the TA update/maintenance mechanism, shown in the following sections.

In a set of embodiments, the S-DU transmits to the UE a second downlink indication, in response to the detection that the C-DU does not successfully receive the first uplink message/signal (e.g., a PRACH preamble) and when a maximum number of uplink signal (e.g., RA preamble) transmission attempts (e.g., parameter max_attemtps_TA_establishment_LTM, set by the C-DU and indicated to the S-DU) has not been reached. In other words, this is a pre-condition monitored at the S-DU for determining the transmission of the second downlink indication. When that maximum number has been reached, the S-DU does not transmit the second downlink indication to the UE, and instead the S-DU declares a TA establishment failure.

When the S-DU transmits the first downlink indication to the UE, the S-DU initializes a counter for preamble transmission attempts as follows: PREAMBLE_TRANSMISSION_COUNTER=1. Thus, before transmitting the second downlink indication (or any other downlink indication after the first downlink indication) the S-DU determines whether the maximum number of uplink signal (e.g., RA preamble) transmission attempts has been reached. For example, the C-DU may have configured the maximum number of uplink signal (e.g., RA preamble) transmission attempts to 5. Thus, when the S-DU verifies that PREAMBLE_TRANSMISSION_COUNTER<5, it transmits the second downlink indication and increments the counter as follows

$$PREAMBLE\_TRANSMISSION \_COUNTER = PREAMBLE\_TRANSMISSION \_COUNTER + 1.$$

Based on the monitoring of the counter, the S-DU prevents an infinite amount of uplink signal re-transmissions/uplink signal transmission attempts to an LTM candidate cell that may be out of reach by the UE, so unnecessary uplink interference is prevented in the LTM candidate. This may also give the opportunity to the S-DU (or the CU) to trigger the release of a candidate LTM (remove the LTM candidate at the UE and at the C-DU) that cannot be reached by the UE in the uplink.

In a set of embodiments, the S-DU transmits to the UE a second downlink indication, in response to the detection that the C-DU does not successfully receive the first uplink message/signal (e.g., a PRACH preamble) but only when the maximum uplink signal (RA preamble) transmission power has not been reached, after a number of transmission by the UE.

According to the method, in a set of embodiments, because the UE does not expect a RAR from the LTM candidate cell in response to the first uplink signal/message, it is the S-DU that indicates to the UE that the UE shall transmit a second uplink message in case of a failed detection at the C-DU for the first uplink message.

A difference compared to a legacy RA with a cell: in legacy RA, when the UE does not receive the RAR within the RAR time window, the UE either transmits a preamble with power ramping (e.g., based on the same beam/SSB which it has previously selected) or the UE selects a new beam/SSB/CSI-RS, mapping to a second RA resource (e.g., in this case without power ramping).

The method comprises different solutions for indicating to the UE whether the UE needs to perform power ramping or not for the second uplink signal transmission triggered by the second downlink indication.

In one option, the S-DU indicates to the UE (e.g., in the second downlink indication), in response to the RA preamble attempt failure (e.g., expiry of supervision timer), that the UE shall re-transmit the first uplink message and/or that the UE shall transmit another uplink signal/message according to the previously transmitted RA resource configuration with an incremented transmission power, in comparison to the previously used transmission power for the first uplink signal/message.

In one option, the S-DU indicates to the UE (e.g., in the second downlink indication), in response to the RA preamble attempt failure (e.g., expiry of supervision timer), that the UE shall transmit the second uplink signal/message according to the previously transmitted RA resource configuration with an incremented transmission power, in comparison to the previously used transmission power for the first uplink signal/message. Here the second uplink signal/message does not have to the same as the first uplink signal/message, as long as the same SSB/CSI-RS/beam is selected and the mapped RA resource configuration (or configuration pool or set) is the same as in the case of the first uplink signal/message transmission.

In one option, the S-DU indicates to the UE (e.g., in the second downlink indication), in response to the RA preamble attempt failure (e.g., expiry of supervision timer), that the UE shall select a beam (e.g., SSB or CSI-RS) which is different than the previously selected beam (e.g., SSB or CSI-RS) that led to a failed attempt of RA preamble transmission.

In one option, the S-DU indicates which SSB the UE needs to select, and consequently how the RA resource selection occurs based on the indicated SSB. In one option, the S-DU indicates which CSI-RS the UE needs to select, and consequently how the RA resource selection occurs based on the indicated CSI-RS.

In one option, the S-DU does not indicate the exact SSB the UE needs to select, but it indicates that it needs to be an SSB for a RA resource selection based on it. In one option, the S-DU does not indicate the exact CSI-RS the UE needs to select, but it indicates that it needs to be a CSI-RS for a RA resource selection based on it.

In one option, the S-DU gives some freedom to the UE, i.e., the S-DU does not indicate to the UE (e.g., in the second downlink indication) whether the UE shall select a new beam/SSB/CSI-RS or perform power ramping. Instead, the second downlink indication indicates that there was an uplink signal preamble attempt, but the steps related to the fallback are left to the UE.

In one option, the UE determines whether it performs power ramping based on the RA resource selection. The UE performs power ramping when the RA resource selection leads to the UE selecting the same SSB or CSI-RS or beam which has been selected in the failed attempt. The UE does not perform power ramping when the RA resource selection leads to the UE selecting a different SSB or CSI-RS or beam which has been selected in the failed attempt.

In this option, the second downlink indication replaces the event of the UE detecting that a RAR was not received (within a RAR time window) in response to the first uplink signal/message transmission. Herein, it is the reception of a second downlink indication that makes the UE trigger a new attempt to transmit RA preamble to the LTM candidate cell, not the lack of the reception of a RAR.

In step 6(2), in a set of embodiments, the UE transmits a second uplink message/signal (e.g., a second RA preamble, transmitted to the candidate cell according to: i) an incremented transmission power compared to the first transmission power (e.g., the initial RA preamble power possibly defined by a parameter/field preambleReceivedTargetPower), or ii) to a second uplink resource (e.g., RA resources in time and frequency) associated to a second beam the UE selects.

In a set of embodiments, the UE transmits a second uplink message/signal (e.g., a second RA preamble, transmitted to the candidate cell according to one or more indication(s) included in the second downlink indication, e.g. as defined in the abovementioned sets of embodiments.

In a set of embodiments, before the UE transmits a second uplink message/signal, the UE performs an uplink resource selection (e.g., RA resource selection based on a beam selection) for the TA establishment/update fallback, comprising one or more of the following steps.

The UE may perform or update one or more measurements on beams and/or SSBs and/or CSI-RS resources of the LTM candidate cell for which the UE needs to perform the fallback of the TA establishment, e.g. SSB RSRP measurement(s) for one or more SSBs, such as SS-RSRP of SSB index=1, SS-RSRP of SSB index=2, . . . , SS-RSRP of SSB index=k; e.g. CSI-RS RSRP measurement(s) for one or more CSI-RS(s).

The UE may perform an uplink channel resource selection based on a selected beam/SSB/CSI-RS, e.g. RACH resource selection, associated to an SSB and/or CSI-RS resource of the LTM candidate cell for which the UE needs to establish the TA. For example, the UE selects an SSB or CSI-RS resource for which a measurement is above a threshold (potentially configured in the uplink configuration), e.g. SSB RSRP>rsrp-ThresholdSSB; and the UE selects an uplink channel resource (e.g., time/frequency resources and preamble) for TA establishment associated to the selected SSB, wherein the association is also part of the uplink configuration.

The UE may transmit a second uplink message (e.g., a second RA preamble) to the LTM candidate cell, wherein the second uplink message (e.g., second RA preamble) is transmitted to the LTM candidate cell according to: i) an incremented transmission power compared to the first transmission power, or ii) on a second uplink resource (e.g., RA resources in time and frequency) associated to a second beam (e.g., SSB or CSI-RS of the LTM candidate cell) the UE selects.

In one option, when an indication of the second uplink signal (e.g., RA preamble) is provided to the UE (ra-PreambleIndex by PDCCH, or other uplink signal indication in the second downlink indication) the UE selects the SSB signaled by the second downlink indication, e.g., by PDCCH (so the UE uses the RA resource(s) mapped to that selected SSB).

In one option, the UE selects the indicated SSB when the RSRP of the indicated SSB is above the SSB threshold. This may be the case when the UE is sending CSI reports to the S-DU for SSBs of the LTM candidate cells, so the S-DU indicates in the downlink indication and SSB that is known to the S-DU to be in good enough radio conditions.

In one option, the UE uses the indicated RA preamble for the second uplink signal/message transmission (e.g., by setting the PREAMBLE_INDEX to the signaled preamble).

In one option, the UE sets a variable for the preamble transmission to the signaled preamble, e.g., set the variable PREAMBLE_INDEX to the signaled ra-PreambleIndex.

In one option, the UE selects an SSB with SS-RSRP (as defined in TS 38.215) above rsrp-ThresholdSSB amongst the associated SSBs.

In one option, the UE sets the PREAMBLE_INDEX to a ra-PreambleIndex corresponding to the selected SSB.

In one option, the UE selects the CSI-RS signaled, e.g., by PDCCH.

In one option, the UE selects a CSI-RS resource with CSI-RSRP (as defined in TS 38.215) above rsrp-ThresholdCSI-RS amongst the associated CSI-RSs.

In one option, the UE sets the PREAMBLE_INDEX to a ra-PreambleIndex corresponding to the selected CSI-RS.

In one option, the UE selects an SSB and when an SSB is selected, the UE determines the next available PRACH occasion from the PRACH occasions corresponding to the selected SSB permitted by the restrictions given by a configuration (e.g., the ra-ssb-OccasionMaskIndex, part of the uplink configuration for TA establishment) if configured or indicated by PDCCH (the MAC entity at the UE selects select a PRACH occasion randomly with equal probability amongst the consecutive PRACH occasions, corresponding to the selected SSB).

In one option, the UE (e.g., the MAC entity at the UE) accounts for the possible occurrence of measurement gaps when determining the next available PRACH occasion corresponding to the selected SSB.

In one option, the UE selects a CSI-RS and determines the next available PRACH occasion from the PRACH occasions in a configured RA occasion list/set (e.g., ra-OccasionList) corresponding to the selected CSI-RS. The UE (e.g., the MAC entity at the UE) selects a PRACH occasion randomly with equal probability amongst the PRACH occasions occurring simultaneously but on different subcarriers, corresponding to the selected CSI-RS.

In one option, the UE (e.g., the MAC entity at the UE) accounts for the possible occurrence of measurement gaps when determining the next available PRACH occasion corresponding to the selected CSI-RS.

In one option, when the UE determines if there is an SSB with SS-RSRP above rsrp-ThresholdSSB or a CSI-RS with CSI-RSRP above rsrp-ThresholdCSI-RS, the UE uses the latest unfiltered L1-RSRP measurement.

In one option, the UE does not maintain a counter for preamble transmissions (e.g., PREAMBLE_TRANSMISSION_COUNTER) which would be maintained in a RA procedure. The reason is that this is controlled by the network (e.g., S-DU), which controls the need for a fallback procedure (i.e., RA preamble re-transmissions with power ramping and/or beam/SSB/CSI-RS re-selection without reaching a maximum number of preamble transmissions attempts). Thus, in this network controlled fallback, it is the network (e.g., S-DU) that monitors the number of preamble transmissions, e.g., by controlling a preamble transmission counter, which is incremented each time the UE is indicated to transmit a RA preamble for the TA establishment for LTM.

In a set of embodiments, the UE transmits a second uplink message/signal for the TA establishment/update fallback with an increased power (e.g., with a power ramping step) compared to the first transmission power transmit when the selected beam (e.g., SSB or CSI-RS) is the same beam the UE has selected during resource selection for the transmission of the first uplink message/signal.

In one option, the UE sets the transmission power for the second uplink message/signal (PREAMBLE_RECEIVED_TARGET_POWER(2)) to be an incremented power compared to the first transmission power, wherein the transmission power for the second uplink message/signal is set by adding up one or more of: a value provided in the uplink configuration (e.g., preambleReceivedTargetPower); a delta value which depends on the RA preamble format (e.g., 0 dB for preamble format 0), e.g. DELTA_PREAMBLE; a value indicated in the downlink indication or an indication in the downlink indication that enables the UE to derive a value to be added to the first transmission power; and/or an increment step based on a preamble power ramping step (e.g., PREAMBLE_POWER_RAMPING_STEP) and a preamble power ramping counter (e.g., PREAMBLE_POWER_RAMPING_COUNTER). For example: Increment step=(PREAMBLE_POWER_RAMPING_COUNTER1)×PREAMBLE_POWER_RAMPING_STEP; So that the transmission power may be, for example, set as: PREAMBLE_RECEIVED_TARGET_POWER=preambleReceivedTargetPower+DELTA_PREAMBLE+Increment step→PREAMBLE_RECEIVED_TARGET_POWER to preambleReceivedTargetPower+DELTA_PREAMBLE+(PREAMBLE_POWER_RAMPING_COUNTER−1)×PREAMBLE_POWER_RAMPING_STEP.

In one option, the UE monitors the power ramping counter (e.g., PREAMBLE_POWER_RAMPING_COUNTER). The power ramping counter is incremented by 1 when a RA preamble is transmitted/re-transmitted as part of the same TA establishment/update procedure. The power ramping counter has a maximum value associated to it, and the UE may be configured with that maximum value as part of the uplink channel configuration.

In one option, the UE is configured with a PREAMBLE_POWER_RAMPING_STEP, e.g., received in the RRC Reconfiguration including the LTM configuration, and/or as part of the uplink channel configuration.

In one option, the UE receives in a downlink indication (e.g., second downlink indication that triggers the RA preamble transmission for TA establishment) an indication of a PREAMBLE_POWER_RAMPING_STEP, e.g., a pointer to a value.

In a set of embodiments, the UE transmits a second uplink message/signal for the TA establishment/update to an LTM candidate cell and, when the UE does not receive a downlink indication (e.g., a third downlink indication) in response from a serving cell (e.g., from the S-DU), the UE considers the TA establishment procedure successful.

In a set of embodiments, the UE transmits an n-th uplink message/signal for the TA establishment/update to an LTM candidate cell and, when the UE does not receive an (n+1)-th downlink indication from a serving cell (e.g., from the S-DU), the UE considers the TA establishment procedure successful. Based on that, the UE performs one or more actions such as the reset of at least one counter (set them to zero) and the stopping of at least one timer associated to the TA establishment procedure.

In a set of embodiments, the UE further receives the third downlink indication from the S-DU based on which the UE transmits a third uplink message (e.g., a third RA preamble) to the candidate cell, wherein the third uplink message (e.g., third RA preamble) transmitted to the candidate cell is transmitted according to: i) an incremented transmission power compared to the second transmission power, or ii) to a third uplink resource (e.g., RA resources in time and frequency) associated to a third beam the UE selects.

Some embodiments include fallback repetition until success or detection of TA establishment failure. In a set of embodiments, the fallback for TA establishment is repeated until one or more conditions are fulfilled. The fallback for TA establishment comprises the S-DU transmitting to the UE (and the UE receiving) an (n+1)-th downlink indication, after the S-DU has transmitted to the UE an n-th downlink indication which led to an n-th preamble transmission failure for TA establishment/update, wherein the (n+1)-th downlink indication indicates to the UE that the UE shall perform the transmission of an (n+1)-th uplink message, either with an increased an incremented transmission power compared to the transmission power of the n-th uplink message transmission; and/or indicating that the transmission of an (n+1)-th uplink message is to be towards an (n+1)-th uplink resource (e.g., RA resources in time and frequency) associated to an (n+1)-th beam the UE selects.

The one or more conditions may correspond to: the S-DU detects a preamble transmission failure for TA establishment/update; and/or the S-DU detects that a number of preamble transmission failure for TA establishment/update reaches a maximum value, for a given LTM candidate cell and/or UE.

In one option, the maximum value may have been configured by the candidate DU responsible for the LTM candidate cell, which is the C-DU that has configured the uplink resources for the TA establishment and/or TA updating.

In one option, the S-DU increments a counter each time it detects a preamble transmission failure for TA establishment/update (e.g., based on one or more of the solutions proposed above). The S-DU, before transmitting a downlink indication to the UE, checks if the counter reached the maximum value. When the S-DU determines the counter has reached the maximum value, the S-DU does not transmit the downlink indication and considers the TA establishment as failure, referred to as a TA establishment failure.

In other words, when the number of preamble transmission failures for TA establishment reaches its maximum value, the S-DU declares a TA establishment failure.

In one option, the maximum value for the number of preamble transmission failures for TA establishment may have been configured by the candidate DU responsible for the LTM candidate cell, which is the C-DU that has configured the uplink resources for the TA establishment and/or TA updating.

The S-DU detects that a maximum transmission power for the UE to transmit the uplink message to the LTM candidate cell has been reached.

The maximum value may be reached after a number of transmission power increments, after preamble transmission failures for TA establishment.

In one option, the maximum transmission power for TA establishment may have been configured by the candidate DU responsible for the LTM candidate cell, which is the C-DU that has configured the uplink resources for the TA establishment and/or TA updating.

In a set of embodiments, the candidate DU successfully receives the first uplink message/signal (e.g., a PRACH preamble), so it is able to calculate a timing advance value for a UE and at least one LTM candidate cell. The Candidate DU transmits a message to the CU including the at least one timing advance value.

In one embodiment, the candidate DU transmits the message to the CU comprising a timing advance value and one or more associated LTM candidate cell(s) for which the TA value is applicable. Based on that, the CU (and possibly the serving DU, also receiving that information) knows that a given timing advance value is applicable to one or more LTM candidate cell(s) the UE is configured with, which may be needed during LTM execution (also referred to as LTM cell switch) to one of the candidate cells.

In one embodiment, the candidate DU transmits the message to the CU using a UE signaling connection, so that the CU is aware that a timing advance value associated to a target candidate cell corresponds to the UE for that UE signaling connection.

In one embodiment, when the candidate DU transmits the message to the CU the candidate DU starts a timer, which may be referred to as a TA timer. And, while the TA timer is running the candidate DU considers the timing advance value that it has provided to the CU as “valid”, which means that while the TA timer is running the candidate DU may receive that incoming UE with LTM without random access, because the timing advance is still valid, assuming that TA value is provided to the UE via CU and/or serving DU. When the TA timer expires, the candidate DU considers the TA value as “not valid” and, when the TA value is not valid, the candidate DU may trigger a TA update procedure.

In one embodiment, the CU receives the message including the TA value associated to a target candidate cell and a UE configured for LTM and the CU starts a TA timer. While the TA timer is running, the CU considers the TA value as “valid”; when the TA timer expires the CU considers the TA value as “not valid”. When the TA value is not valid, the CU may trigger a TA update procedure.

In one option, the candidate DU further includes in the message to the CU the TA timer value associated to a TA value (applicable for at least one target candidate cell), wherein the TA value is considered “valid” while the TA timer is running, and not valid when the TA timer expires. In that case, it may be an option that the candidate DU also starts a TA timer with the same or similar value, so that it may also be aware when the TA value is not valid for that UE and the LTM candidate cell.

In one embodiment, the first uplink signal and/or RA resource may have been configured for a specific UE (e.g., per UE resource, contention-free preamble and/or PRACH resources for TA establishment), so that at the reception the candidate DU knows to which UE this is associated, and consequently to which CU this is associated, as for that UE there is a UE-signaling connection (as that is a UE for which the candidate DU has accepted the request for configuring LTM). The candidate DU, based on the reception of the first uplink signal/message, calculates the TA value for that UE and the target candidate cell, and transmits that TA value to the serving DU (via the CU), to be used by the UE in the LTM execution (i.e., the LTM cell switch, at a later moment).

In one set of embodiments, the CU transmits a message to the serving DU in which the UE is connected, including the at least one TA value. As in step (7a) in FIG. 5C, the candidate DU receives the first uplink signal (e.g., a PRACH preamble) in an uplink channel (PRACH time/frequency resource slot) allocated for the purpose of TA establishment for LTM, calculates a TA value, valid for a UE and at least one LTM candidate cell, and the candidate DU transmits a message to the CU comprising the at least one TA value, so that the CU transmits to the serving DU.

In one embodiment, the serving DU receives the message from the CU comprising a TA value and one or more associated LTM candidate cell(s), for which the TA value is applicable. Based on that, the serving DU knows that a given TA value is applicable to one or more LTM candidate cell(s) the UE is configured with, which may be needed during LTM execution (LTM cell switch) to one of these candidate cells.

In one embodiment, the serving DU receives the message from the CU in a UE signaling connection, so that the serving DU is aware that a TA value associated to an LTM candidate cell corresponds to the UE for that UE signaling connection.

In one embodiment, the serving DU receives the message including the TA value associated to an LTM candidate cell and a UE configured for LTM and the serving DU starts a timer (may be referred to as a TA timer). While the TA timer is running, the serving DU considers the TA value as “valid”; when the TA timer expires the serving DU considers the TA value as “not valid”. When the TA value is not valid, the serving DU may trigger an TA update procedure.

In one option, the serving DU receives in the message from the CU the TA timer value associated to a TA value (applicable for at least one target candidate cell), wherein the TA value is considered “valid” while the TA timer is running, and not valid when the TA timer expires. In that case, it may be an option that the candidate DU and/or the CU also starts a TA timer with the same or similar value, so that it may also be aware when the TA value is not valid for that UE and the LTM candidate cell.

In one set of embodiments, the S-DU is responsible for monitoring whether the UE transmission of the uplink message to the candidate DU for TA establishment is successful. In other words, the S-DU determines whether there is a preamble transmission failure for TA establishment/update. There may be different options to define these failure monitoring steps.

In one option, when the message including the TA value is received, the S-DU stops the timer that was started when the S-DU indicates to the UE to transmit the first uplink signal/message, and considers the TA establishment procedure successful.

In one option, when the message including the TA value is received, the S-DU considers the TA establishment procedure successful.

In a set of embodiments, the UE may transmit measurements to assist the serving DU and/or the candidate DU and/or the CU to trigger the LTM execution (LTM cell switch), e.g. including CSI measurements for an LTM candidate cell for which the UE has triggered the establishment of the TA.

In response to the reported measurements (L1 RSRP) for a given LTM candidate cell, the network (e.g., the serving DU) may determine to trigger LTM cell switch for the UE to the LTM candidate cell for which the UE has triggered the establishment of the TA.

In one embodiment, the serving DU performs one or more of the following actions. If the LTM candidate cell (e.g., cell X) for which the serving DU determines to trigger LTM execution (cell switch) is a cell for which the serving DU has a valid TA value (e.g., TA timer is running, UE is considered to be time aligned with the LTM candidate cell, uplink synchronized) for the UE and that LTM candidate cell, then the serving DU transmits to the UE a lower layer signaling (e.g., MAC CE) indicating that LTM candidate cell and includes the TA value to be applied by the UE for communication with the LTM candidate cell (which becomes the target cell). If the LTM candidate cell (e.g., cell X) for which the serving DU determines to trigger LTM execution (LTM cell switch) is a cell for which the serving DU has not a valid TA value (e.g., TA timer has expired) for the UE and that target candidate cell, then the serving DU transmits to the UE a lower layer signaling (e.g., MAC CE) indicating that LTM candidate cell and not including a TA value.

In one embodiment, the serving DU performs one or more of the following actions. If the TA timer is running, the network (e.g., serving DU) transmits to the UE a lower layer signaling (e.g., MAC CE) indicating the LTM candidate cell and includes the TA value. If the TA timer had expired or stopped, the network (e.g., serving DU) transmits to the UE a lower layer signaling (e.g., MAC CE) indicating the LTM candidate cell for L1/L2 inter-cell mobility not including the TA value.

In one embodiment, the serving DU performs one or more of the following actions. If the LTM candidate cell (e.g., cell X) for which the serving DU LTM execution (LTM cell switch) is a cell for which the serving DU has a valid TA value (e.g., TA timer is running) for the UE and that LTM candidate cell which is the same as the TA value for a serving cell the UE is configured with, then the serving DU transmits to the UE a lower layer signaling (e.g., MAC CE) indicating that LTM candidate cell and includes that TA value for that serving cell the UE is configured with, to be applied by the UE for communication with the LTM candidate cell

Another alternative is that instead of providing the TA value, the serving DU provides a serving cell index, indicating to the UE that the UE shall use the TA value between the UE and the serving cell whose index has been indicated as the TA value for the UE and the LTM candidate cell, also indicated in the lower layer signaling.

The UE receives the lower layer signaling (e.g., MAC CE) indicating the LTM candidate cell. When the signaling includes the TA value, the UE applies that TA value for the LTM candidate cell (for uplink transmissions). When the signaling does not include the TA value or when the indicated LTM candidate cell is a cell for which TA is the same as a serving cell (and the UE is aware of that based on the LTM candidate configuration), the UE applies the TA value of the associated serving cell for that LTM candidate cell (for uplink transmissions). When the signaling does not include the TA value or the indicated LTM candidate cell is a cell for which time alignment (uplink synchronization) has not been established, the UE performs random access to the LTM candidate cell indicated. When the signaling includes a serving cell index, the UE uses the TA value between the UE and the serving cell whose index has been indicated as the TA value for the UE and the LTM candidate cell, also indicated in the lower layer signaling.

The UE transmits an uplink message to the target candidate (e.g., over PUCCH and/or PUSCH) after having applied the indicated TA value for the LTM candidate cell according to the method.

Some embodiments include fallback steps for TA update for LTM. In a set of embodiments, one or more steps disclosed for TA establishment fallback may be performed in the case of a TA update: when the TA value is not valid for the UE and an LTM candidate and the network and/or the UE determines to calculate a new TA value before the LTM execution with that LTM candidate cell.

According to particular embodiments, the TA updates may be triggered by: i) the CU; ii) the S-DU; iii) the C-DU; and/or iv) the UE.

The triggering may depend on which of those entities are managing the validity of the TA value that has been previously calculated by the C-DU and provided to the S-DU.

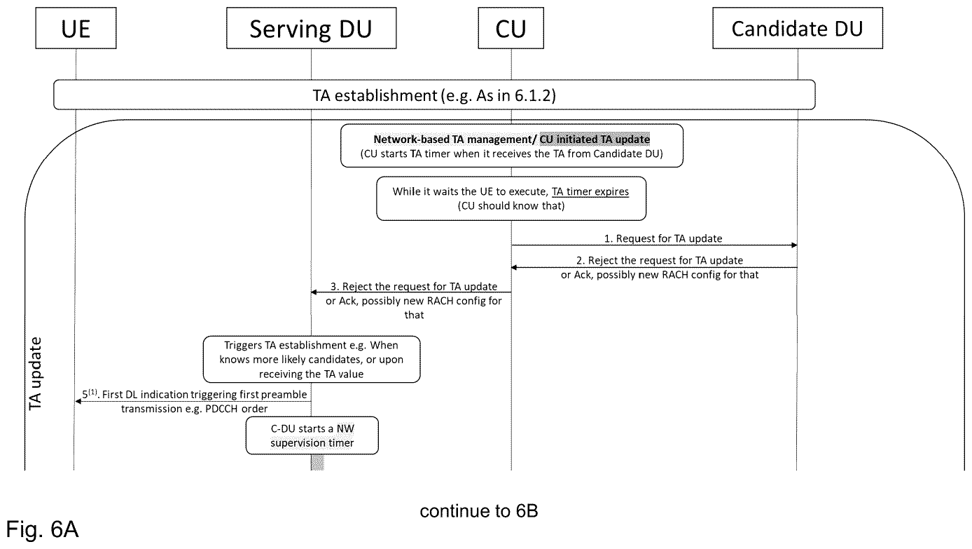

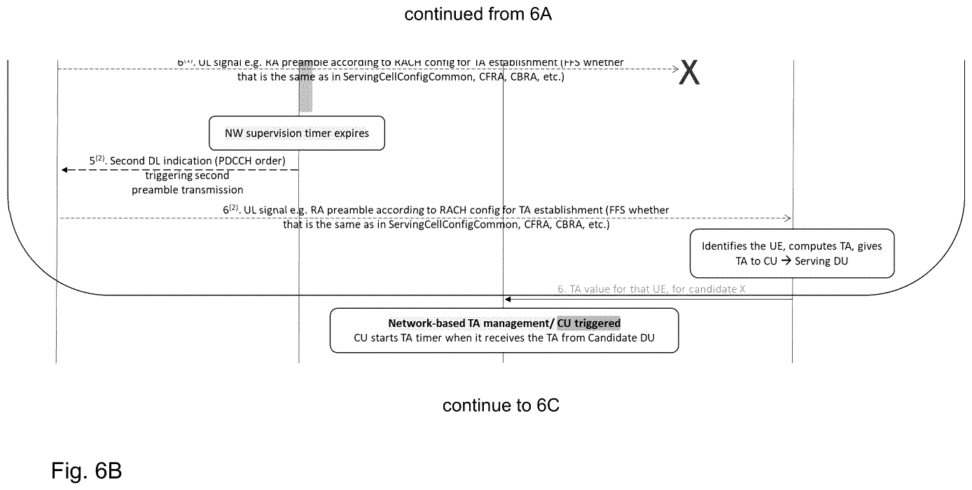

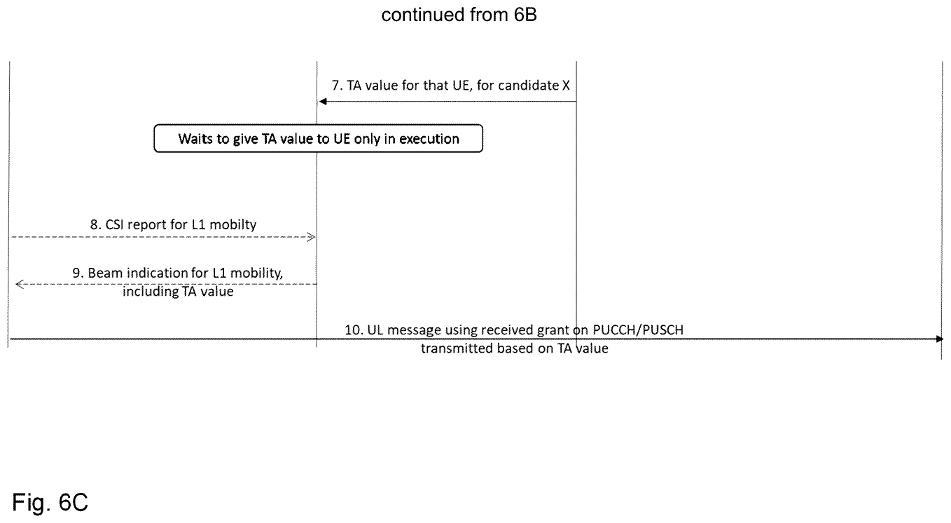

In a set of embodiments, the TA establishment between a UE and an LTM candidate is performed, and the CU determines that the TA value is not valid, e.g., upon expiry of a TA timer value. The TA timer may have been started when the TA value was provided to the CU and/or the S-DU. When the CU detects that the TA value is not valid (which may be equivalent to determining that the UE has lost synchronization in the uplink with the LTM candidate cell) the CU sends a request for TA update to the C-DU (for the LTM candidate cell for which the UE has lost uplink synchronization, e.g., for which the TA timer has expired). In response the C-DU may reject or accept the request, potentially with a new uplink channel configuration for uplink transmissions (e.g., RACH config) for the UE, because the previously provided configuration(s) may contain one or more parameters that are not valid. (3) The CU transmits an indication of reject or acceptance to the S-DU, which triggers the TA establishment/update to the UE, e.g., by transmitting a first downlink indication. From that point, the steps for the TA update are similar to the steps disclosed above, as shown in FIGS. 5A, 5B and 5C, and to some extent reproduced below in FIGS. 6A, 6B and 6C.

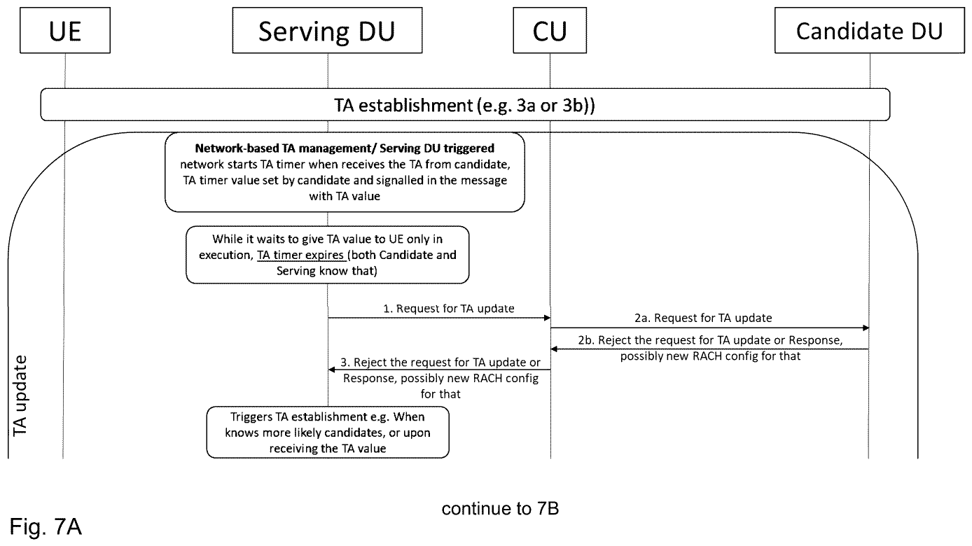

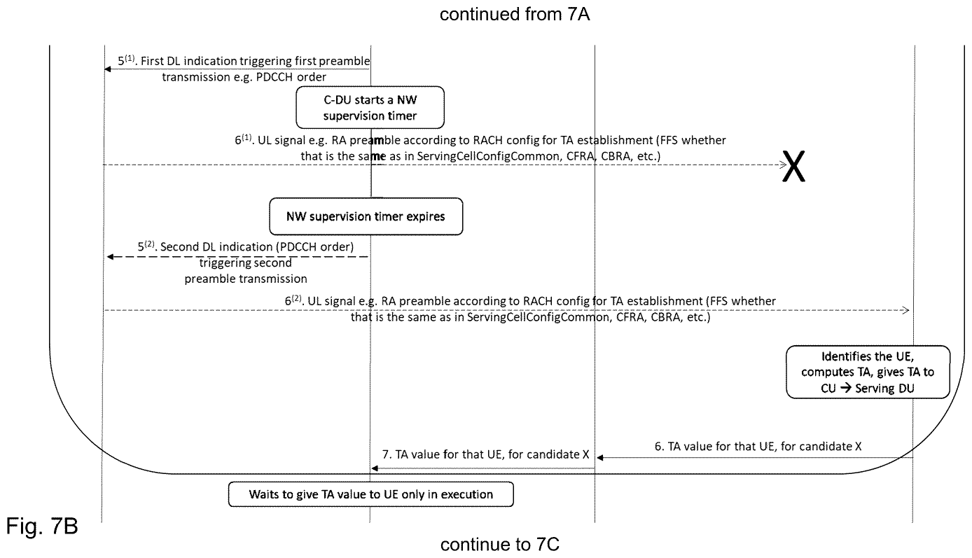

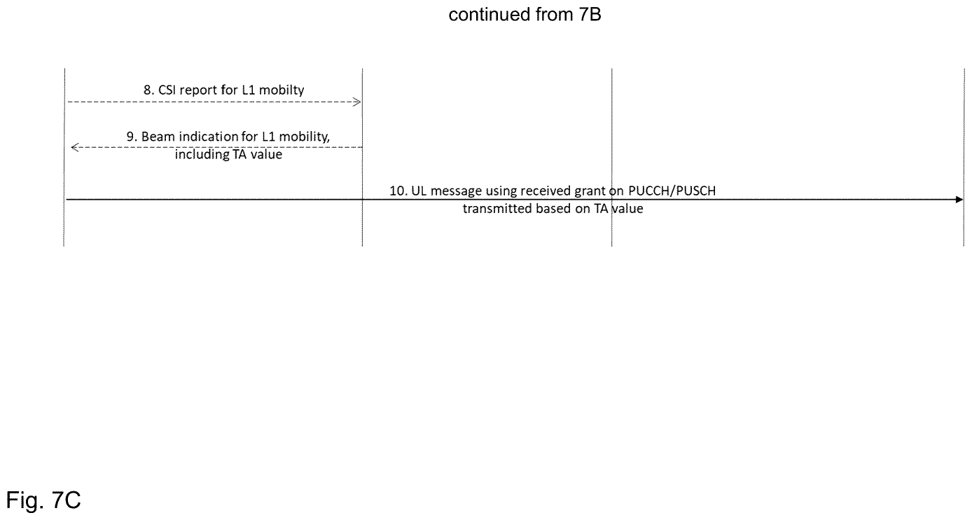

FIGS. 6A, 6B and 6C is a flowchart illustrating a fallback procedure for the TA update procedure (for a CU initiated TA update and a network-based TA management). In a set of embodiments, the TA establishment between a UE and an LTM candidate is performed, and the S-DU determines that the TA value is not valid, e.g., upon expiry of a TA timer value. The TA timer may have been started when the TA value was provided to the S-DU, e.g., from the C-DU upon reception of an uplink signal from the UE in a TA establishment procedure. When the S-DU detects that the TA value is not valid (which may be equivalent to determining that the UE has lost synchronization in the uplink with the LTM candidate cell) the S-DU sends a (1) request for TA update to the CU, (2) which transmits the request to the C-DU (wherein the C-DU is responsible for the LTM candidate cell for which the UE has lost uplink synchronization, e.g., for which the TA timer has expired). In response (2b), the C-DU may reject or accept the request, potentially with a new uplink channel configuration for uplink transmissions (e.g., RACH configuration) for the UE, because the previously provided configuration(s) may contain one or more parameters that are not valid. The CU transmits an indication of reject or acceptance to the S-DU, which triggers the TA establishment/update to the UE, e.g., by transmitting a first downlink indication. From that point, the steps for the TA update are similar to the steps disclosed above, as shown in FIGS. 5A, 5B and 5C, and to some extent reproduced below in FIGS. 7A, 7B and 7C.

FIGS. 7A, 7B and 7C is a flowchart illustrating another fallback procedure for the TA update procedure (for an S-DU initiated TA update and a network-based TA management). Some embodiments include actions upon detecting a TA establishment/update failure. In a set of embodiments, the S-DU detects a TA establishment/update failure (e.g., when the maximum number of RA preamble transmission attempts for TA establishment/update is reached) and indicates that to the CU, so the CU may take one or more of the further actions.

The CU cancels the TA establishment/update for LTM towards the C-DU for the LTM candidate cell in which the UE has attempted to establish or update the TA and has failed. In one option, the CU transmits a message (e.g., a UE Context Modification Request) to the C-DU for canceling the TA establishment. In response, the C-DU releases and/or cancels one or more uplink resources reserved for the TA establishment/update procedure. The C-DU may also stop monitoring the uplink messages from the UE for TA establishment and/or update.

The CU cancels the TA establishment at the UE, e.g., by generating and transmitting to the UE an RRC Reconfiguration message removing/releasing/canceling/deactivating one or more configuration(s) for the TA establishment/update for the LTM candidate cell.

The CU cancels LTM towards the C-DU for the LTM candidate cell in which the UE has attempted to establish/update TA and has failed. In one example, the CU then considers the candidate target cell to instead be a candidate for a normal (L3) handover or it configures the UE with a conditional handover (CHO) configuration where it is the candidate target cell. In one alternative, the CU then sends a message to the C-DU that cancels LTM for the LTM candidate cell as well as includes a request for a CHO configuration (or a configuration for a normal handover) for the same cell.

The CU provides to the C-DU (or to another network node, e.g. OAM-Operation and Maintenance) information related to the TA establishment failure, e.g., measurements on beams (e.g., SSBs and/or CSI-RS) of the LTM candidate cell in which the UE has attempted to establish TA and has failed and/or beams which were not selected by the UE for TA establishment.

In a set of embodiments, when the S-DU detects a TA establishment failure (e.g., when the maximum number of RA preamble transmission attempts for TA establishment is reached), the S-DU may decide to initiate a new TA establishment with a new C-DU. In such a case, the S-DU sends a new request for a TA establishment with a new C-DU. In one alternative, the S-DU decides to initiate a new TA establishment for another candidate target cell in the same C-DU as where the TA establishment failure was detected.

In one alternative, when the S-DU detects a TA establishment/update failure (e.g., when the maximum number of RA preamble transmission attempts for TA establishment is reached), the S-DU decides to not trigger an LTM cell switch (LTM execution) to that LTM candidate cell. In one example, the S-DU does then not trigger any LTM switch to the candidate target cell for a certain period of time. When that time has passed, the S-DU may decide to first initiate a new TA establishment/update procedure towards the same candidate target cell. In one option, the S-DU has a timer to determine when an LTM cell switch (LTM execution) to that LTM candidate cell can again be triggered or to determine when a new TA establishment/update procedure towards the same candidate target cell should be initiated. The timer is started when the S-DU detects a TA establishment/update failure. In one example, there is also a corresponding timer in the UE.

In another example, the S-DU initiates a new TA establishment/update procedure towards the same candidate target cell when it has received measurements for that cell that, e.g., indicate that the radio conditions towards that cell has improved for the UE.

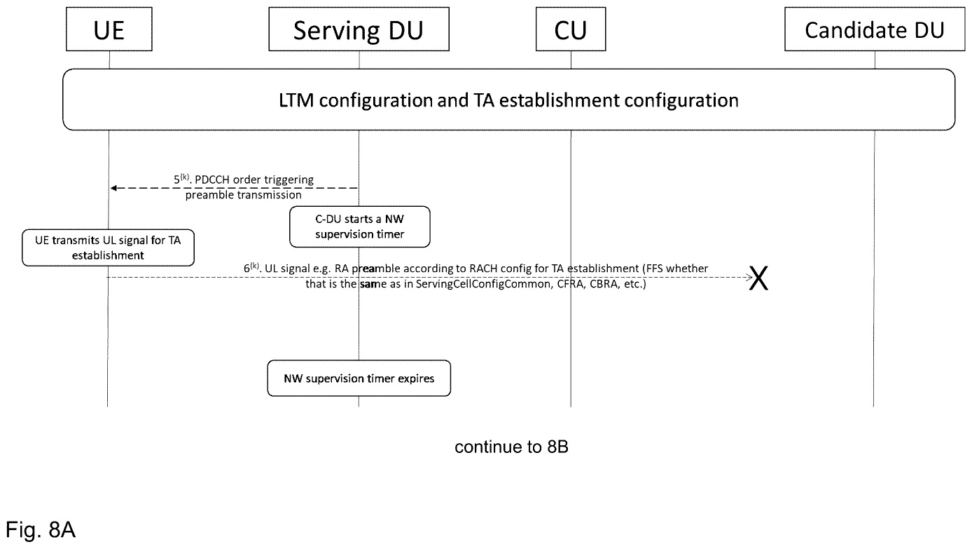

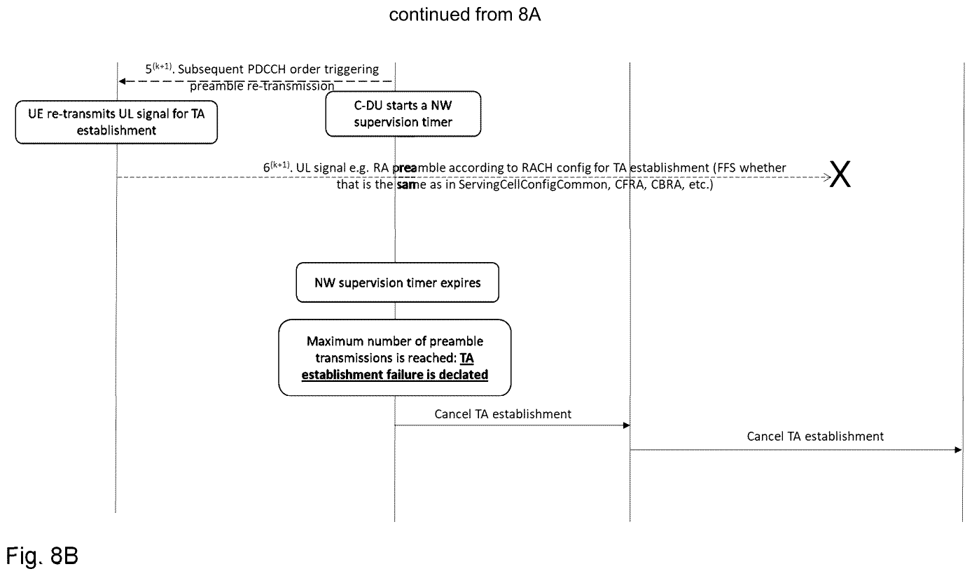

In another alternative, when the S-DU detects a TA establishment failure (e.g., when the maximum number of RA preamble transmission attempts for TA establishment is reached) and an LTM cell switch (LTM execution) is later triggered towards that same LTM candidate cell, the S-DU may include an indication to the UE (with the LTM cell switch command) to perform a random access procedure as part of the LTM cell switch procedure to that candidate target cell. In a set of embodiments, the UE monitors the TA establishment failure: the UE detects that a maximum number of RA preamble transmission(s) have been reached and, upon detecting the failure the UE releases one or more TA establishment resources such as the uplink configuration for TA establishment/updates. An example is illustrated in FIGS. 8A and 8B.

FIGS. 8A and 8B is a flowchart illustrating an example of actions at the S-DU upon detecting a TA establishment failure. In a legacy RA procedure, it is the UE that detects the need for fallback (e.g., by the absence of a RAR in response to a preamble transmissions) and, the detection of a RA failure, e.g., when a maximum number of transmission attempts is reached. When a RA failure is triggered, the UE performs one or more recovery actions, such as the initiation of an RRC Re-establishment procedure (in case the RA failure is on the Master Cell Group and MCG Failure recovery is not supported; or the initiation of the transmission of an SCG Failure related message (in case the RA failure is on the Secondary Cell Group). However, in the sets of embodiments described herein, the network detects the TA establishment failure, and, because the UE is still connected with the serving cell(s) there is no need to trigger recovery actions, such as a re-establishment procedure.

As described herein, the network either triggers the UE to re-initiate a TA establishment procedure, to the same and/or to another LTM candidate cell and/or cancel the TA establishment procedure.

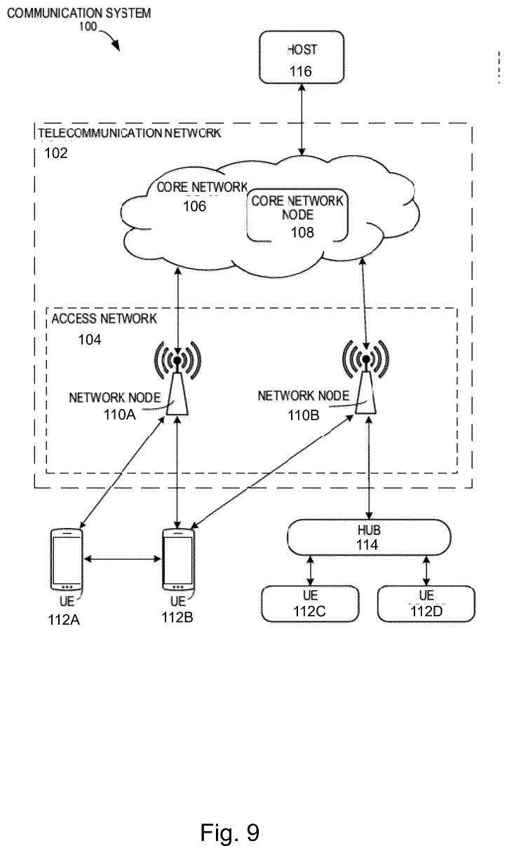

FIG. 9 illustrates an example of a communication system 100 in accordance with some embodiments. In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3rd Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

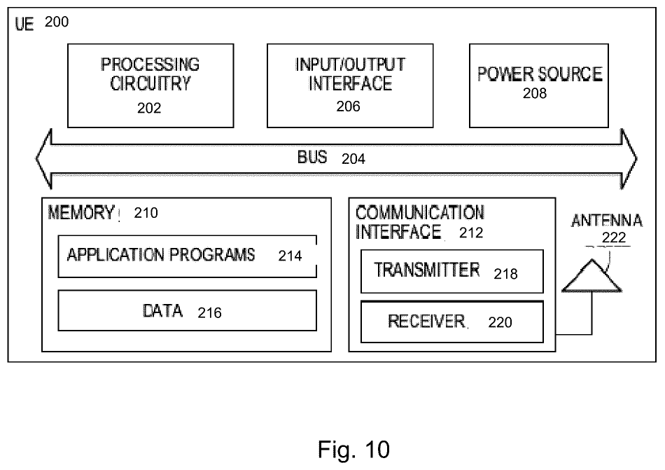

FIG. 10 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 10.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

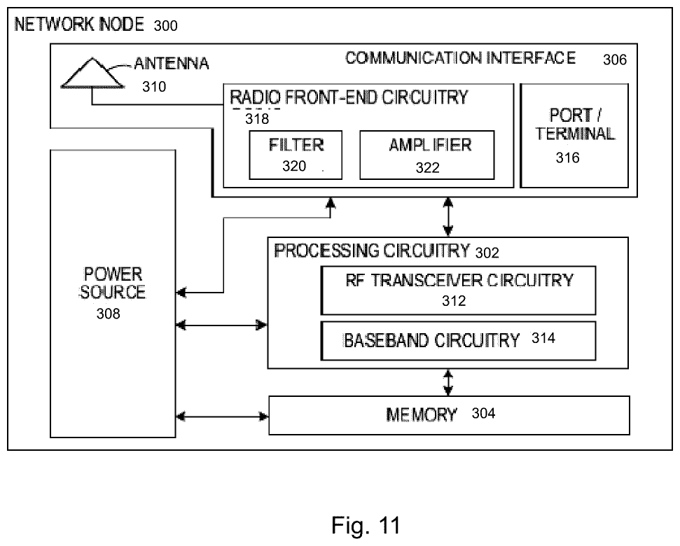

FIG. 11 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 11 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

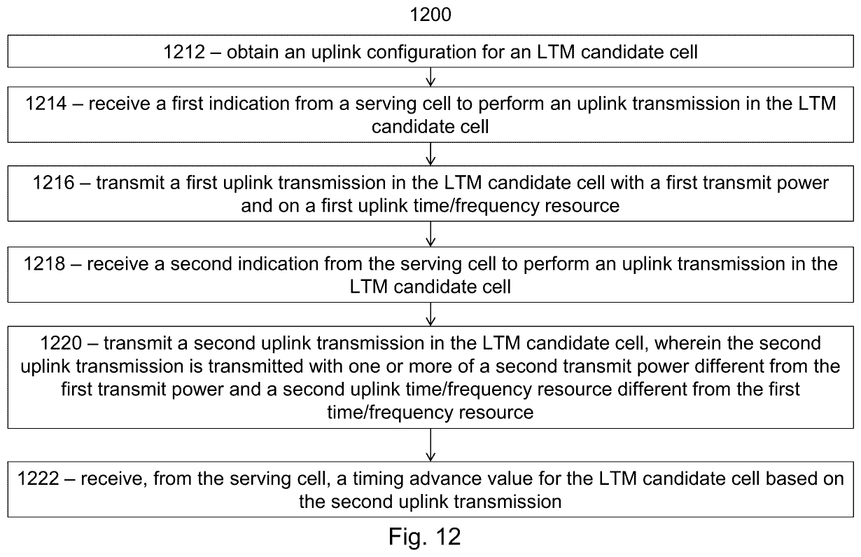

FIG. 12 is a flowchart illustrating an example method in a wireless device, according to certain embodiments. In particular embodiments, one or more steps of FIG. 12 may be performed by user equipment 200 described with respect to FIG. 10. The wireless device is capable of LTM.

The method begins at step 1212, where the wireless device (e.g., UE 200) obtains an uplink configuration for an LTM candidate cell. For example, the wireless device may obtain the uplink configuration for the LTM candidate cell via RRC. Examples of uplink configurations for LTM candidate cells are described in more detail with respect to the embodiments and examples described above.

At step 1214, the wireless device receives a first indication (e.g., PDCCH order, RRC message, MAC CE, etc.) from a serving cell to perform an uplink transmission in the LTM candidate cell. Examples of the first indication are described in more detail with respect to the embodiments and examples described above.

At step 1216, the wireless device transmits a first uplink transmission (e.g., random access preamble) in the LTM candidate cell with a first transmit power and on a first uplink time/frequency resource. The wireless device does not expect a response (e.g., RAR) to the first uplink transmission.

In some embodiments, the wireless device selects a first beam, and based on the selected first beam, the UE selects a first uplink resource associated to the first beam for transmitting the first uplink message.

Examples of transmitting the uplink transmission are described in more detail with respect to the embodiments and examples described above.

The first uplink transmission may not have been received by the LTM candidate cell, or the LTM candidate cell may not have been able to calculate a timing advance for the wireless device, for example, in which case the serving cell is able to determine a failure occurred and the method continues to step 1218.

At step 1218, the wireless device receives a second indication (e.g., PDCCH order, RRC message, MAC CE, etc.) from the serving cell to perform an uplink transmission in the LTM candidate cell. Examples of the second indication are described in more detail with respect to the embodiments and examples described above.

At step 1220, the wireless device transmits a second uplink transmission (e.g., random access preamble) in the LTM candidate cell. The second uplink transmission is transmitted with one or more of a second transmit power different from the first transmit power and a second uplink time/frequency resource different from the first time/frequency resource.

For example, in particular embodiments, the first uplink transmission uses a first beam and in response to receiving the second indication to perform the uplink transmission, the method further comprises selecting a second beam to use for the second uplink transmission and when the second beam is the same as the first beam the second transmission is transmitted with a second transmit power different from the first transmit power and when the second beam is different from the first beam the second transmission is transmitted with a second uplink time/frequency resource different from the first time/frequency resource.

In particular embodiments, the second indication to perform the uplink transmission comprises an indication of a second transmission power or an indication of a second uplink time/frequency resource to use for the second uplink transmission.

In particular embodiments, the uplink configuration for the uplink candidate cell comprises one or more random access parameters and at least one of the first indication and the second indication comprises an indication of which of the one or more random access parameters to use for the first uplink transmission or the second uplink transmission, respectively.

In particular embodiments, at least one of the first indication and the second indication comprises an indication of a SSB associated with the first uplink transmission or the second uplink transmission, respectively.

In particular embodiments, the uplink configuration for the uplink candidate cell comprises more than one uplink configuration for more than one uplink candidate cell and at least one of the first indication and the second indication comprises an indication of which uplink candidate cell in which to transmit the first uplink transmission or the second uplink transmission, respectively.

Examples of transmitting the second uplink transmission are described in more detail with respect to the embodiments and examples described above.

At step 1222, the wireless device receives, from the serving cell (e.g., S-DU), a timing advance value for the LTM candidate cell based on the second uplink transmission. In particular embodiments, receiving the timing advance value from the serving cell comprises receiving an LTM execution command. Examples of receiving the timing advance value are described in more detail with respect to the embodiments and examples described above.

Modifications, additions, or omissions may be made to method 1200 of FIG. 12. Additionally, one or more steps in the method of FIG. 12 may be performed in parallel or in any suitable order.

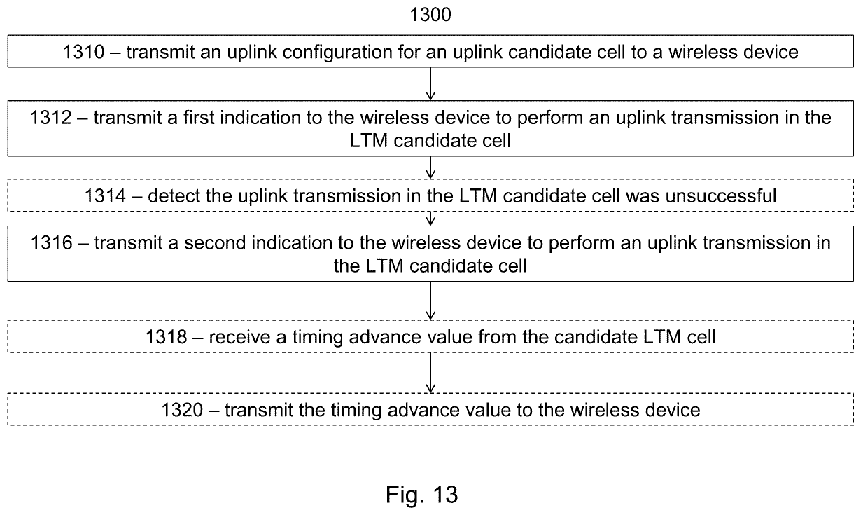

FIG. 13 is a flowchart illustrating an example method in a network node, according to certain embodiments. In particular embodiments, one or more steps of FIG. 13 may be performed by network node 300 described with respect to FIG. 11. The network node is capable of operating as S-DU for TA management between a wireless device and at least one LTM candidate cell.

The method may begin at step 1310, where the network node (e.g., network node 300) transmits an uplink configuration for the uplink candidate cell to the wireless device. Examples of uplink configurations are described in more detail with respect to the embodiments and examples described above.

At step 1312, the network node transmits a first indication to the wireless device to perform an uplink transmission in the LTM candidate cell. Examples of the first indication are described in more detail with respect to the embodiments and examples described above.

At step 1314, the network node detects the uplink transmission in the LTM candidate cell was unsuccessful. For example, in particular embodiments, detecting the uplink transmission in the LTM candidate cell was unsuccessful comprises not receiving a response from the LTM candidate cell or receiving an indication from the LTM candidate cell that the uplink transmission in the LTM candidate cell was unsuccessful. Examples of detecting the uplink transmission in the LTM candidate cell was unsuccessful are described in more detail with respect to the embodiments and examples described above.

At step 1316, the network node transmits a second indication to the wireless device to perform an uplink transmission in the LTM candidate cell.

In particular embodiments, the first uplink transmission and the second uplink transmission comprise transmission of a random access preamble.

In particular embodiments, the second indication to perform the uplink transmission comprises an indication of a transmission power or an uplink time/frequency resource to use for the second uplink transmission.

In particular embodiments, the uplink configuration for the uplink candidate cell may comprise one or more random access parameters and at least one of the first indication and the second indication comprises an indication of which of the one or more random access parameters to use for the first uplink transmission or the second uplink transmission, respectively. The uplink configuration for the uplink candidate cell may comprise more than one uplink configuration for more than one uplink candidate cell and at least one of the first indication and the second indication comprises an indication of which uplink candidate cell in which to transmit the first uplink transmission or the second uplink transmission, respectively.

In particular embodiments, at least one of the first indication and the second indication comprises an indication of a synchronization signal block, SSB, associated with the first uplink transmission or the second uplink transmission, respectively.

In particular embodiments, transmitting the second indication to the wireless device to perform the uplink transmission comprises determining a threshold number of uplink transmissions for the wireless device and the LTM candidate cell has not been exceeded.

Examples of the second indication are described in more detail with respect to the embodiments and examples described above.

At step 1318, the network node may receive a timing advance value from the candidate LTM cell and at step 1320, the network node may transmit the timing advance value to the wireless device. In particular embodiments, transmitting the timing advance value to the wireless device comprises transmitting a LTM execution command to the wireless device.

Modifications, additions, or omissions may be made to method 1300 of FIG. 13. Additionally, one or more steps in the method of FIG. 13 may be performed in parallel or in any suitable order.

Modifications, additions, or omissions may be made to the methods disclosed herein without departing from the scope of the invention. The methods may include more, fewer, or other steps. Additionally, steps may be performed in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

Some example embodiments are included below.

### Group A Embodiments

1. A method performed by a wireless device for L1/L2 triggered mobility (LTM), the method comprising:
obtaining an uplink configuration for a LTM candidate cell;
receiving an first indication from a serving cell to perform an uplink transmission in the LTM candidate cell;
transmitting a first uplink transmission in the LTM candidate cell with a first transmit power and on a first uplink time/frequency resource;
receiving a second indication from the serving cell to perform an uplink transmission in the LTM candidate cell;
transmitting a second uplink transmission in a second LTM candidate cell, wherein the second uplink transmission is transmitted with one or more of a second transmit power different from the first transmit power and a second uplink time/frequency resource different from the first time/frequency resource.

2. The method of embodiment 1, wherein the second LTM candidate cell is the same cell as the first LTM candidate cell.

3. The method of embodiment 1, wherein the second LTM candidate cell is a different cell than the first LTM candidate cell.

4. A method performed by a wireless device, the method comprising:
any of the wireless device steps, features, or functions described above, either alone or in combination with other steps, features, or functions described above.

5. The method of the previous embodiment, further comprising one or more additional wireless device steps, features or functions described above.

6. The method of any of the previous embodiments, further comprising:
providing user data; and
forwarding the user data to a host computer via the transmission to the base station.

### Group B Embodiments

7. A method performed by a base station operating as a Serving Distributed Unit (SDU) for timing advance (TA) management between a wireless device and at least one L1/L2 triggered mobility (LTM) candidate cell, the method comprising:
transmitting a first indication to a wireless device to perform an uplink transmission in the LTM candidate cell;
detecting the uplink transmission in the LTM candidate cell was unsuccessful; and
transmitting a second indication to the wireless device to perform an uplink transmission in the LTM candidate cell.

8. A method performed by a base station, the method comprising:
any of the steps, features, or functions described above with respect to base station (e.g., Serving DU, Candidate DU, etc.), either alone or in combination with other steps, features, or functions described above.

9. The method of the previous embodiment, further comprising one or more additional base station steps, features or functions described above.

10. The method of any of the previous embodiments, further comprising:
obtaining user data; and
forwarding the user data to a host computer or a wireless device.

### Group C Embodiments

11. A mobile terminal comprising:
processing circuitry configured to perform any of the steps of any of the Group A embodiments; and
power supply circuitry configured to supply power to the wireless device.

12. A base station comprising:
processing circuitry configured to perform any of the steps of any of the Group B embodiments;
power supply circuitry configured to supply power to the wireless device.

13. A user equipment (UE) comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

14. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform any of the steps of any of the Group B embodiments.

15. The communication system of the pervious embodiment further including the base station.

16. The communication system of the previous 2 embodiments, further including the UE, wherein the UE is configured to communicate with the base station.

17. The communication system of the previous 3 embodiments, wherein:
the processing circuitry of the host computer is configured to execute a host application, thereby providing the user data; and
the UE comprises processing circuitry configured to execute a client application associated with the host application.

18. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs any of the steps of any of the Group B embodiments.

19. The method of the previous embodiment, further comprising, at the base station, transmitting the user data.

20. The method of the previous 2 embodiments, wherein the user data is provided at the host computer by executing a host application, the method further comprising, at the UE, executing a client application associated with the host application.

21. A user equipment (UE) configured to communicate with a base station, the UE comprising a radio interface and processing circuitry configured to performs any of the previous 3 embodiments.

22. A communication system including a host computer comprising:
processing circuitry configured to provide user data; and
a communication interface configured to forward user data to a cellular network for transmission to a user equipment (UE),
wherein the UE comprises a radio interface and processing circuitry, the UE's components configured to perform any of the steps of any of the Group A embodiments.

23. The communication system of the previous embodiment, wherein the cellular network further includes a base station configured to communicate with the UE.

24. The communication system of the previous 2 embodiments, wherein:
the processing circuitry of the host computer is configured to execute a host application, thereby providing the user data; and
the UE's processing circuitry is configured to execute a client application associated with the host application.

25. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs any of the steps of any of the Group A embodiments.

26. The method of the previous embodiment, further comprising at the UE, receiving the user data from the base station.

27. A communication system including a host computer comprising:
communication interface configured to receive user data originating from a transmission from a user equipment (UE) to a base station,
wherein the UE comprises a radio interface and processing circuitry, the UE's processing circuitry configured to perform any of the steps of any of the Group A embodiments.

28. The communication system of the previous embodiment, further including the UE.

29. The communication system of the previous 2 embodiments, further including the base station, wherein the base station comprises a radio interface configured to communicate with the UE and a communication interface configured to forward to the host computer the user data carried by a transmission from the UE to the base station.

30. The communication system of the previous 3 embodiments, wherein:
the processing circuitry of the host computer is configured to execute a host application; and
the UE's processing circuitry is configured to execute a client application associated with the host application, thereby providing the user data.

31. The communication system of the previous 4 embodiments, wherein:
the processing circuitry of the host computer is configured to execute a host application, thereby providing request data; and
the UE's processing circuitry is configured to execute a client application associated with the host application, thereby providing the user data in response to the request data.

32. A method implemented in a communication system including a host computer, a base station and a user equipment (UE), the method comprising:
at the host computer, receiving user data transmitted to the base station from the UE, wherein the UE performs any of the steps of any of the Group A embodiments.

33. The method of the previous embodiment, further comprising, at the UE, providing the user data to the base station.

34. The method of the previous 2 embodiments, further comprising:
at the UE, executing a client application, thereby providing the user data to be transmitted; and
at the host computer, executing a host application associated with the client application.

35. The method of the previous 3 embodiments, further comprising:
at the UE, executing a client application; and
at the UE, receiving input data to the client application, the input data being provided at the host computer by executing a host application associated with the client application,
wherein the user data to be transmitted is provided by the client application in response to the input data.

36. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.

37. The communication system of the previous embodiment further including the base station.

38. The communication system of the previous 2 embodiments, further including the UE, wherein the UE is configured to communicate with the base station.

39. The communication system of the previous 3 embodiments, wherein:
the processing circuitry of the host computer is configured to execute a host application;
the UE is configured to execute a client application associated with the host application, thereby providing the user data to be received by the host computer.

40. A method implemented in a communication system including a host computer, a base station and a user equipment (UE), the method comprising:
at the host computer, receiving, from the base station, user data originating from a transmission which the base station has received from the UE, wherein the UE performs any of the steps of any of the Group A embodiments.

41. The method of the previous embodiment, further comprising at the base station, receiving the user data from the UE.

42. The method of the previous 2 embodiments, further comprising at the base station, initiating a transmission of the received user data to the host computer.

1. A method performed by a wireless device for layer one, L1/layer two, L2, triggered mobility, LTM, the method comprising:
obtaining an uplink configuration for an LTM candidate cell;
receiving a first indication from a serving cell to perform an uplink transmission in the LTM candidate cell;
transmitting a first uplink transmission in the LTM candidate cell with a first transmit power and on a first uplink time/frequency resource;
receiving a second indication from the serving cell to perform an uplink transmission in the LTM candidate cell;
transmitting a second uplink transmission in the LTM candidate cell, wherein the second uplink transmission is transmitted with one or more of a second transmit power different from the first transmit power and a second uplink time/frequency resource different from the first time/frequency resource; and
receiving, from the serving cell, a timing advance value for the LTM candidate cell based on the second uplink transmission.

2. The method of claim 1, wherein the first uplink transmission and the second uplink transmission comprise transmission of a random access preamble.

3. The method of claim 2, wherein the wireless device does not expect a random access response, RAR, in response to the transmission of the random access preamble.

4. The method of claim 1, wherein the first uplink transmission uses a first beam and in response to receiving the second indication to perform the uplink transmission, the method further comprises selecting a second beam to use for the second uplink transmission and when the second beam is the same as the first beam the second transmission is transmitted with a second transmit power different from the first transmit power and when the second beam is different from the first beam the second transmission is transmitted with a second uplink time/frequency resource different from the first time/frequency resource.

5. The method of claim 1, wherein the second indication to perform the uplink transmission comprises an indication of a second transmission power or an indication of a second uplink time/frequency resource to use for the second uplink transmission.

6. The method of claim 1, wherein the first indication and the second indication comprise a physical downlink control channel, PDCCH, order.

7. The method of claim 1, wherein receiving the timing advance value from the serving cell comprises receiving an LTM execution command.

8. The method of claim 1, wherein the uplink configuration for the uplink candidate cell comprises one or more random access parameters and at least one of the first indication and the second indication comprises an indication of which of the one or more random access parameters to use for the first uplink transmission or the second uplink transmission, respectively.

9. The method of claim 1, wherein at least one of the first indication and the second indication comprises an indication of a synchronization signal block, SSB, associated with the first uplink transmission or the second uplink transmission, respectively.

10. The method of claim 1, wherein the uplink configuration for the uplink candidate cell comprises more than one uplink configuration for more than one uplink candidate cell and at least one of the first indication and the second indication comprises an indication of which uplink candidate cell in which to transmit the first uplink transmission or the second uplink transmission, respectively.

11. A wireless device capable of layer one, L1/layer two, L2, triggered mobility, LTM, the wireless device comprising processing circuitry operable to:
obtain an uplink configuration for an LTM candidate cell;
receive a first indication from a serving cell to perform an uplink transmission in the LTM candidate cell;
transmit a first uplink transmission in the LTM candidate cell with a first transmit power and on a first uplink time/frequency resource;
receive a second indication from the serving cell to perform an uplink transmission in the LTM candidate cell;
transmit a second uplink transmission in the LTM candidate cell, wherein the second uplink transmission is transmitted with one or more of a second transmit power different from the first transmit power and a second uplink time/frequency resource different from the first time/frequency resource; and
receive, from the serving cell, a timing advance value for the LTM candidate cell based on the second uplink transmission.

12.-20. (canceled)

21. A method performed by a network node operating as a serving distributed unit, S-DU, for timing advance, TA, management between a wireless device and at least one layer one, L1/layer two, L2, triggered mobility, LTM, candidate cell, the method comprising:
transmitting a first indication to the wireless device to perform an uplink transmission in the LTM candidate cell; and
transmitting a second indication to the wireless device to perform an uplink transmission in the LTM candidate cell.

22. The method of claim 21, further comprising transmitting the second indication to the wireless device to perform the uplink transmission in the LTM candidate cell upon detecting the uplink transmission in the LTM candidate cell was unsuccessful.

23. (canceled)

24. The method of claim 22, wherein detecting the uplink transmission in the LTM candidate cell was unsuccessful comprises receiving an indication from the LTM candidate cell that the uplink transmission in the LTM candidate cell was unsuccessful.

25. The method of claim 21, wherein the first uplink transmission and the second uplink transmission comprise transmission of a random access preamble.

26. The method of claim 21, wherein the second indication to perform the uplink transmission comprises an indication of a transmission power or an uplink time/frequency resource to use for the second uplink transmission.

27. The method of claim 21, wherein the first indication and the second indication comprise a physical downlink control channel, PDCCH, order.

28. The method of claim 21, further comprising:
receiving a timing advance value from the candidate LTM cell; and
transmitting the timing advance value to the wireless device.

29. (canceled)

30. The method of claim 21, wherein transmitting the second indication to the wireless device to perform the uplink transmission comprises determining a threshold number of uplink transmissions for the wireless device and the LTM candidate cell has not been exceeded.

31. The method of claim 21, further comprising transmitting an uplink configuration for the uplink candidate cell to the wireless device.

32.-33. (canceled)

34. The method of claim 21, wherein at least one of the first indication and the second indication comprises an indication of a synchronization signal block, SSB, associated with the first uplink transmission or the second uplink transmission, respectively.

35. A network node-capable of operating as a serving distributed unit, S-DU, for timing advance, TA, management between a wireless device and at least one layer one, L1/layer two, L2, triggered mobility, LTM, candidate cell, the network node comprising processing circuitry operable to:
transmit a first indication to the wireless device to perform an uplink transmission in the LTM candidate cell;
detect the uplink transmission in the LTM candidate cell was unsuccessful; and
transmit a second indication to the wireless device to perform an uplink transmission in the LTM candidate cell.

36.-48. (canceled)
